(19) United States
(12) Patent Application Publication
(10) Pub. No.: US 2021/0063974 A1
(43) Pub. Date: Mar. 4, 2021

(54) METHOD FOR REINFORCEMENT LEARNING, RECORDING MEDIUM STORING REINFORCEMENT LEARNING PROGRAM, AND REINFORCEMENT LEARNING APPARATUS

(71) Applicant: FUJITSU LIMITED, Kawasaki-shi (JP)

(72) Inventors: Yoshihiro OKAWA, Yokohama (JP); Tomotake Sasaki, Kawasaki (JP); Hidenao Iwane, Kawasaki (JP); Hitoshi Yanami, Kawasaki (JP)

(73) Assignee: FUJITSU LIMITED, Kawasaki-shi (JP)

(21) Appl. No.: 17/001,706

(22) Filed: Aug. 25, 2020

(30) Foreign Application Priority Data
Aug. 27, 2019 (JP) 2019-154803

(51) Int. Cl. G05B 13/04; G06N 5/02; G06N 7/00; G05B 17/02

(52) U.S. Cl. CPC G05B 13/042; G05B 17/02; G06N 7/005; G06N 5/02

(57) ABSTRACT

A method for reinforcement learning performed by a computer is disclosed. The method includes: predicting a state of a target to be controlled in reinforcement learning at each time point to measure a state of the target, the time point being included in a period from a time point to determine a present action to a time point to determine a subsequent action; calculating a degree of risk concerning the state of the target at the each time point with respect to a constraint condition based on a result of prediction; specifying a search range concerning the present action to the target in accordance with the calculated degree of risk and a degree of impact of the present action to the target on the state of the target at the each time point; and determining the present action to the target based on the specified search range.

### CROSS-REFERENCE TO RELATED APPLICATION

This application is based upon and claims the benefit of priority of the prior Japanese Patent Application No. 2019-154803, filed on Aug. 27, 2019, the entire contents of which are incorporated herein by reference.

### FIELD

The embodiments discussed herein are related to a method for reinforcement learning, a recording medium storing a reinforcement learning program, and a reinforcement learning apparatus.

### BACKGROUND

There has been a technique called reinforcement learning, which is designed to refer to immediate costs or immediate rewards from a target corresponding to an action to the target, and to learn a policy for optimizing a value function that defines a value of the action to the target based on a cumulative cost or a cumulative reward from the target. The value function is a state-action value function (Q function), a state value function (V function), or the like.

For example, Japanese Laid-open Patent Publication No. 2014-206795 discloses a technique designed to obtain an update range of a model parameter of a policy function approximated by a linear model, and to update and record the model parameter in the obtained update range at certain time intervals. Japanese Laid-open Patent Publication No. 2011-65553 discloses a technique designed to update action values by using a gradient according to a natural gradient method, which is obtained by converting a gradient in spaces for action values for an amount of update for an action value corresponding to a state and amounts of update for action values corresponding to sub-states obtained by further dividing the former state into pieces. Japanese Laid-open Patent Publication No. 2017-157112 discloses a technique designed to determine a search range of a control parameter based on knowledge information in which an amount of change in control parameter used for calculating an operation signal is associated with an amount of change in state of a plant.

### SUMMARY

According to an aspect of the embodiments, a method for reinforcement learning of causing a computer to execute a process includes: predicting a state of a target to be controlled in reinforcement learning at each time point to measure a state of the target, the time point being included in a period from after a time point to determine a present action to a time point not later than determination of a subsequent action, on a condition that a time interval to measure the state of the target is different from a time interval to determine the action to the target; calculating a degree of risk concerning the state of the target at the each time point with respect to a constraint condition concerning the state of the target based on a result of prediction of the state of the target; specifying a search range concerning the present action to the target in accordance with the calculated degree of risk concerning the state of the target at the each time point and a degree of impact of the present action to the target on the state of the target at the each time point; and determining the present action to the target based on the specified search range concerning the present action to the target.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram (No. 1) illustrating an example of a method for reinforcement learning according to an embodiment;

FIG. 2 is an explanatory diagram (No. 2) illustrating the example of the method for reinforcement learning according to the embodiment;

FIG. 3 is a block diagram illustrating a hardware configuration example of a reinforcement learning apparatus;

FIG. 4 is an explanatory diagram illustrating an example of contents stored in a history table;

FIG. 5 is a block diagram illustrating a functional configuration example of the reinforcement learning apparatus;

FIG. 6 is an explanatory diagram (No. 1) illustrating an operation example of the reinforcement learning apparatus;

FIG. 7 is an explanatory diagram (No. 2) illustrating the operation example of the reinforcement learning apparatus;

FIG. 8 is an explanatory diagram (No. 3) illustrating the operation example of the reinforcement learning apparatus;

FIG. 9 is an explanatory diagram (No. 4) illustrating the operation example of the reinforcement learning apparatus;

FIG. 10 is an explanatory diagram (No. 5) illustrating the operation example of the reinforcement learning apparatus;

FIG. 11 is an explanatory diagram (No. 1) illustrating an effect obtained by the reinforcement learning apparatus in the operation example;

FIG. 12 is an explanatory diagram (No. 2) illustrating another effect obtained by the reinforcement learning apparatus in the operation example;

FIG. 13 is an explanatory diagram (No. 1) illustrating a specific example of a target;

FIG. 14 is an explanatory diagram (No. 2) illustrating another specific example of the target;

FIG. 15 is an explanatory diagram (No. 3) illustrating still another specific example of the target;

FIG. 16 is a flowchart illustrating an example of holistic processing procedures; and

FIG. 17 is a flowchart illustrating an example of determination processing procedures.

### DESCRIPTION OF EMBODIMENTS

The conventional techniques are unable to control a probability that a state of a target satisfies a constraint condition concerning the state of the target in the course of learning a policy by reinforcement learning. The target may be adversely affected as a consequence of the state of the target violating the constraint condition concerning the state of the target.

An object of an aspect of this disclosure is to improve a probability that a state of a target satisfies a constraint condition.

An embodiment of a method for reinforcement learning, a reinforcement learning program, and a reinforcement learning apparatus according to this disclosure will be described in detail with reference to the drawings.

(Example of Method for Reinforcement Learning According to Embodiment)

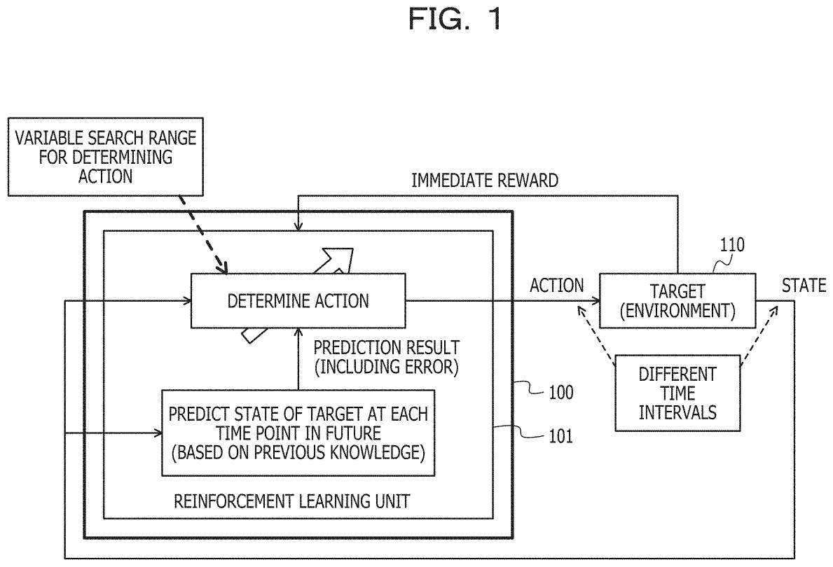

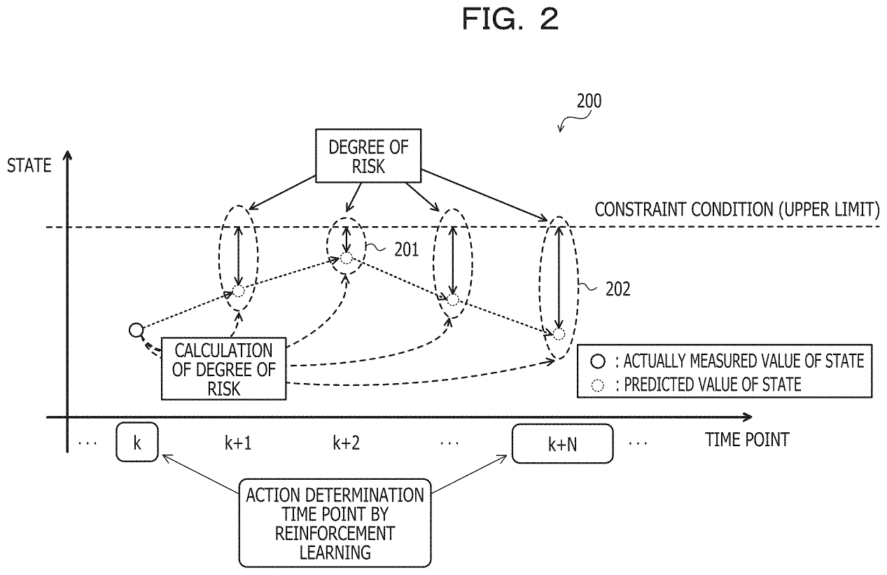

FIGS. 1 and 2 are explanatory diagrams illustrating an example of a method for reinforcement learning according to an embodiment. The reinforcement learning apparatus 100 is a computer for controlling a target 110 by reinforcement learning. The reinforcement learning apparatus 100 is any of a server, a personal computer (PC), and a microcontroller, for example.

The target 110 is a certain entity such as a physical system that exists in reality. The target 110 is also referred to as an environment. The target 110 may exist in a simulator, for example. For example, the target 110 is any of an automobile, an autonomous mobile robot, an industrial robot, a drone, a helicopter, a server room, an air-conditioning facility, a power generation facility, a chemical plant, a game, and the like.

The reinforcement learning is a method of learning a policy to control the target 110. The policy is a control rule for determining an action to the target 110. The action is an operation involving the target 110. The action is also referred to as a control input. For example, the reinforcement learning determines the action to the target 110 and refers to a state of the target 110, the determined action, and an immediate cost or an immediate reward from the target 110 measured in accordance with the determined action, thereby learning a policy for optimizing a value function.

The value function is a function that defines a value concerning the action to the target 110 based on a cumulative cost or a cumulative reward from the target 110. For example, the value function is a state-action value function, a state value function, or the like. The value function is expressed by using a state basis function, for example. The optimization corresponds to minimization regarding the value function based on the cumulative cost and corresponds to maximization regarding the value function based on the cumulative reward. It is also possible to realize the reinforcement learning even when a property of the target 110 is unknown. For example, the reinforcement learning employs Q-learning, SARSA, actor-critic, and the like.

When there is a constraint condition with respect to the state of the target 110, it is desirable not only to learn the policy that makes the target 110 controllable while satisfying the constraint condition but also to satisfy the constraint condition in the course of learning the policy by the reinforcement learning. For example, in an attempt to apply the reinforcement learning to the real target 110 instead of the target 110 in the simulator, the real target 110 may be adversely affected if the constraint condition is violated. This is why it is desirable that the constraint condition is satisfied in the course of learning the policy by the reinforcement learning. The violation means dissatisfaction of the constraint condition.

When the target 110 is a server room and there is a constraint condition to set a temperature in the server room equal to or below a predetermined temperature, for example, a server installed in the server room may be prone to breakdown if the constraint condition is violated. When the target 110 is a windmill and there is a constraint condition to set a revolving speed of the windmill equal to or below a predetermined speed, for example, the windmill may be prone to breakage if the constraint condition is violated. As described above, the real target 110 may be adversely affected if the constraint condition is violated.

However, the previous reinforcement learning does not consider whether or not the state of the target 110 satisfies the constraint condition when the action to the target 110 is determined in the course of learning the policy. As a consequence, the previous reinforcement learning is unable to control a probability that the state of the target 110 violates the constraint condition in the course of learning the policy. The learned policy may not be a policy that makes the target 110 controllable in such a way as to satisfy the constraint condition. Reference is made to the following Non-patent document 1 regarding the previous reinforcement learning.

Non-patent document 1: Doya, Kenji. “Reinforcement learning in continuous time and space”. Neural computation 12. 1 (2000): 219-245.

On the other hand, another possible option is an improved method obtained by modifying the previous reinforcement learning in such a way as to impose a penalty in a case of violation of the constraint condition. Although this improved method is capable of learning the policy that makes the target 110 controllable in such a way as to satisfy the constraint condition, the method is unable to satisfy the constraint condition in the course of learning the policy by the reinforcement learning.

Incidentally, it is not desirable to reduce learning efficiency even when the constraint condition is successfully satisfied in the course of learning the policy by the reinforcement learning. For example, a search range for determining the action may possibly be fixed to a relatively narrow range in the course of learning the policy by the reinforcement learning. However, this mode may cause reduction in learning efficiency and is not desirable from the viewpoint of the learning efficiency.

Still another possible option is a method of reducing a probability of violation of the constraint condition by conducting accurate modeling of the target 110 through a preliminary test and adjusting the search range for determining the action by using an accurate model of the target 110. This method is not applicable to a case where it is difficult to conduct the accurate modeling. This method is also undesirable from the viewpoint of the learning efficiency because the method may cause an increase in burden of calculation in the reinforcement learning when the accurate model of the target 110 is a complicated model. Reference is made to the following Non-patent document 2 regarding this method.

Non-patent document 2: Summers, Tyler, et al. “Stochastic optimal power flow based on conditional value at risk and distributional robustness”. International Journal of Electrical Power & Energy Systems 72 (2015): 116-125.

Yet another possible option is a method of determining a present action to the target 110 from a search range to be defined in accordance with a degree of risk concerning a state of the target 110 at a certain time point in the future with respect to the constraint condition, which is obtained from a prediction result of the state of the target 110 at the certain time point in the future. In this way, the probability of violation of the constraint condition is reduced. This method may also face a difficulty in controlling the probability that the state of the target 110 violates the constraint condition.

For example, a time interval to determine the action to the target 110 may be different from a time interval to measure the state of the target 110. For example, the time interval to determine the action to the target 110 may be longer than the time interval to measure the state of the target 110, and the state of the target 110 may transition two or more times during a period from the determination of the action to the target 110 to the determination of the subsequent action to the target 110. In this case, it is not possible to control the probability of violation of the constraint condition regarding all the transitioning states of the target 110.

For example, the time interval to determine the action may become relatively long if a computing capacity of a computer that carries out the reinforcement learning is relatively low or if there is a time lag until the action actually has an impact on the target 110 due to a reaction speed of an apparatus subjected to the action or due to an environmental reason. For example, the relatively low computing capacity may cause an increase in time consumed for updating a parameter ω that provides the policy, thus resulting in extension of the time interval to determine the action. For this reason, the time interval to determine the action to the target 110 may become longer than the time interval to measure the state of the target 110.

In consideration of the foregoing, this embodiment will describe a method for reinforcement learning of determining a present action to the target 110 from a variable search range. According to this method for reinforcement learning, it is possible to improve the probability that the state of the target 110 satisfies the constraint condition in the course of learning the policy by the reinforcement learning.

As illustrated in FIG. 1, a reinforcement learning apparatus 100 carries out reinforcement learning by repeating a series of processing including determining an action to the target 110 from a variable search range while using a reinforcement learning unit 101, measuring a state of the target 110 and an immediate reward from the target 110, and updating a policy.

In determining the present action to the target 110 in the reinforcement learning, the reinforcement learning apparatus 100 determines and outputs the present action to the target 110 from the variable search range based on a prediction result of the state of the target 110 at each time point in the future, for example. Each time point in the future is equivalent to each time point to measure the state, which is included in a period from after a time point to determine the present action to a time point not later than determination of a subsequent action.

The time interval to determine the action to the target 110 is assumed to be different from the time interval to measure the state of the target 110. For example, the time interval to determine the action to the target 110 is longer than the time interval to measure the state of the target 110, and the state of the target 110 may transition two or more times during the period from first determination of the action to the target 110 to second determination of the action to the target 110 subsequent thereto.

Next, a method of causing the reinforcement learning apparatus 100 to determine the present action will be described with reference to FIG. 2.

As illustrated in FIG. 2, (2-1) the reinforcement learning apparatus 100 acquires a prediction result of the state of the target 110 at each time point in the future when the state is measured in preparation to determine the present action. Each time point in the future is included in the period from after the time point to determine the present action to the time point not later than determination of the subsequent action.

The reinforcement learning apparatus 100 acquires the prediction result of the state of the target 110 by predicting the state of the target 110 at each time point in the future by using previous knowledge concerning the target 110, for example. The previous knowledge includes model information concerning the target 110, for example. For example, the previous knowledge includes model information concerning the state of the target 110 at each time point in the future.

The model information is information that defines a relation between the state of the target 110 and the action to the target 110. When the state of the target 110 and the action to the target 110 at a present time point are inputted, for example, the model information defines a function to output the state of the target 110 at a certain time point in the future. The present time point is a time point when the present action is determined, for example. Each time point in the future is a time point included in the period from after the present time point to the time point not later than determination of the subsequent action.

The reinforcement learning apparatus 100 calculates a degree of risk concerning the state of the target 110 at each time point in the future with respect to the constraint condition based on the prediction result of the state of the target 110 at each time point in the future. The constraint condition is a constraint on the state of the target 110. The degree of risk indicates the degree of likelihood that the state of the target 110 at a certain time point in the future violates the constraint condition, for example.

The example of FIG. 2 will describe a case of setting an upper limit concerning the state of the target 110 as the constraint condition. In this case, the reinforcement learning apparatus 100 calculates the degree of risk concerning the state of the target 110 at the certain time point in the future such that the degree of risk grows larger as a predicted value of the state of the target 110 at the certain time point in the future comes closer to an upper limit within a range equal to or below the upper limit, for example.

A graph 200 in FIG. 2 illustrates the predicted value and an actually measured value of the state of the target 110 at each time point. Each actually measured value is indicated with a solid-line circle. Each predicted value is indicated with a dotted-line circle. The upper limit concerning the state of the target 110 is indicated with a dashed line in a horizontal direction. A time point k is the present time point, which is the time point to determine the present action and is also the time point to measure the state. Time points k+1, k+2, . . . , k+N−1 are time points to measure the state. The time point k+N is the time point to determine the subsequent action and is also the time point to measure the state. Time points k+1, k+2, . . . , k+N correspond to the respective time points in the future to measure the state.

In this case, the reinforcement learning apparatus 100 calculates the degree of risk based on how close the predicted value of the state of the target 110 at each of the time points k+1, k+2, . . . , k+N in the future is to the upper limit, for example. For example, the predicted value of the state of the target 110 at the time point k+2 in the future is relatively close to the upper limit. Accordingly, the degree of risk concerning the state of the target 110 at the time point k+2 in the future is calculated as a relatively large value. For example, the predicted value of the state of the target 110 at the time point k+N in the future is relatively far from the upper limit. Accordingly, the degree of risk concerning the state of the target 110 at the time point k+N in the future is calculated as a relatively small value.

In this way, the reinforcement learning apparatus 100 is capable of obtaining an index for adjusting the search range for determining the present action. The degree of risk concerning the state of the target 110 at the time point k+2 in the future is relatively large, for example. This represents an index of a relatively narrow range 201 in which the state of the target 110 at the time point k+2 in the future does not violate the constraint condition. The degree of risk concerning the state of the target 110 at the time point k+N in the future is relatively small, for example. This represents an index of a relatively wide range 202 in which the state of the target 110 at the time point k+N in the future does not violate the constraint condition.

(2-2) The reinforcement learning apparatus 100 determines the present action based on the search range adjusted in accordance with the degrees of risk concerning the states of the target 110 at the respective time points in the future as well as degrees of impact of the present action on the states of the target 110 at the respective time points in the future. A degree of impact indicates how large a change in the present action will have an impact on a change in the state of the target 110 at each time point in the future, for example.

The higher degree of risk means the narrower range where the state of the target 110 at the time point in the future does not violate the constraint condition. The search range for determining the present action has an impact on a possible range of the state of the target 110 at the time point in the future. For example, if the search range for determining the present action is widened, then the possible range of the state of the target 110 at the time point in the future will be widened as well. Accordingly, as the degree of risk is higher, if the search range for determining the present action is widened, the probability that the state of the target 110 at the time point in the future violates the constraint condition tends to be increased more.

As the degree of impact is higher, it is more likely that the search range for determining the present action has an impact on the possible range of the state of the target 110 at the time point in the future. For example, as the degree of impact is higher, the possible range of the state of the target 110 at the time point in the future is more likely to be widened as a result of widening the search range for determining the present action. Accordingly, as the degree of impact is higher, if the search range for determining the present action is widened, the probability that the state of the target 110 at the time point in the future violates the constraint condition tends to be increased more.

From the above-described tendencies, it is preferable to adjust the search range in such a way as to become narrower as the degree of risk concerning the state of the target 110 at the time point in the future is higher, or to become narrower as the degree of impact on the state of the target 110 at the time point in the future is higher.

The reinforcement learning apparatus 100 determines candidates for the search range for each time point in the future in light of the degree of risk concerning the state of the target 110 at the time point in the future and the calculated degree of risk concerning the state of the target 110 at the time point in the future, for example. The reinforcement learning apparatus 100 sets the candidate for the search range which is the narrowest of the candidates for the search range to the search range concerning the present action, thus determining the present action.

Accordingly, the reinforcement learning apparatus 100 is capable of suppressing the increase in the probability that the state of the target 110 at the time point in the future violates the constraint condition by setting the narrower search range for determining the present action as the degree of risk is higher. The reinforcement learning apparatus 100 is also capable of suppressing the increase in the probability that the state of the target 110 at the time point in the future violates the constraint condition by setting the narrower search range for determining the present action as the degree of impact is higher.

As a consequence, the reinforcement learning apparatus 100 is capable of suppressing the increase in the probability that the state of the target 110 violates the constraint condition in the course of learning the policy by the reinforcement learning. For example, the reinforcement learning apparatus 100 is capable of suppressing the increase in the probability of the violation of the constraint condition in terms of all the states of the target 110 that transition during the period from the first determination of the action to the target 110 to the second determination of the action to the target 110 subsequent thereto.

In the meantime, the reinforcement learning apparatus 100 is capable of suppressing reduction in learning efficiency in learning the policy by the reinforcement learning by widening the search range for determining the action to the target 110 more as the degree of risk is smaller. The reinforcement learning apparatus 100 is capable of suppressing the reduction in learning efficiency in learning the policy by the reinforcement learning also by widening the search range for determining the action to the target 110 more as the degree of impact is smaller.

In some cases, it is desired to enable an evaluation before starting the reinforcement learning as to how much the probability that the state of the target 110 violates the constraint condition is likely to be reduced in the course of learning the policy by the reinforcement learning. For example, in an attempt to apply the reinforcement learning to the real target 110, the real target 110 may be adversely affected if the constraint condition is violated. In this case, it is desired to enable the evaluation before starting the reinforcement learning as to how much the probability that the state of the target 110 violates the constraint condition is likely to be reduced in the course of learning the policy by the reinforcement learning.

On the other hand, the reinforcement learning apparatus 100 is also capable of determining the action to the target 110 so as to guarantee at least a predetermined magnitude of the probability that the state of the target 110 satisfies the constraint condition in the course of learning the policy by the reinforcement learning. In the course of learning the policy by the reinforcement learning of an episode type, for example, the reinforcement learning apparatus 100 is capable of guaranteeing that the probability that the state of the target 110 satisfies the constraint condition becomes equal to or above a preset lower limit at every time point in the episodes.

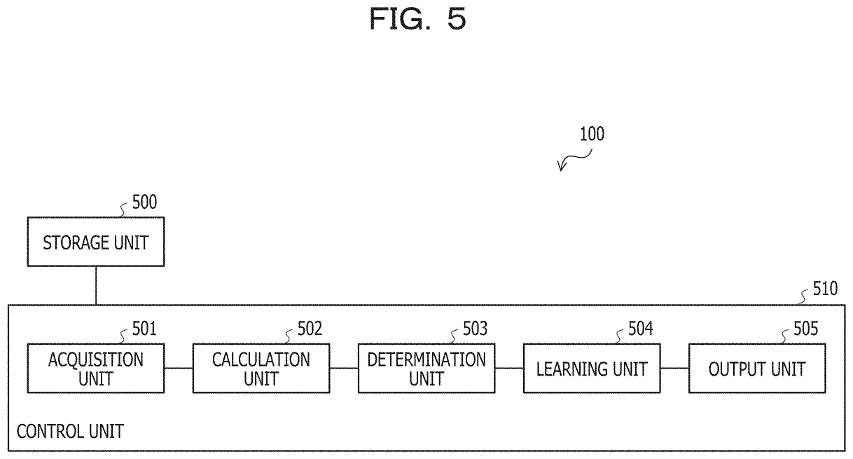

In the reinforcement learning of the episode type, either a period from a point of initialization of the state of the target 110 to a point of discontinuation of satisfaction of the constraint condition by the state of the target 110, or a period from the point of initialization of the state of the target 110 to a lapse of a given length of time is defined as each episode. Each episode is equivalent to a unit of learning. The case of enabling the guarantee of at least the predetermined magnitude of the probability that the state of the target 110 satisfies the constraint condition will be described later in detail in conjunction with an operation example to be explained with reference to FIGS. 5 to 8, for example.

Note that the reinforcement learning apparatus 100 is capable of carrying out the reinforcement learning at relatively high learning efficiency even in a situation where it is difficult to determine what kind of perturbations are supposed to be provided to parameters of the action or of the policy in order to optimize the cumulative cost or the cumulative reward.

Although the description has been made above of the case of setting the single constraint condition, the configuration of the embodiment is not limited only to the foregoing. For example, multiple constraint conditions may be set as appropriate. In this case, the reinforcement learning apparatus 100 increases a probability that the state of the target 110 satisfies the multiple constraint conditions at the same time in the course of learning the policy by the reinforcement learning.

Although the description has been made above of the case where the reinforcement learning apparatus 100 predicts the state of the target 110 at each time point in the future when the state of the target 110 is measured, the embodiment is not limited only to the foregoing. For example, instead of the reinforcement learning apparatus 100, there may be provided a different computer configured to predict the state of the target 110 at each time point in the future when the state of the target 110 is measured.

In this case, the reinforcement learning apparatus 100 acquires from the different computer a prediction result of the state of the target 110 at each time point in the future when the state of the target 110 is measured. The reinforcement learning apparatus 100 calculates the degree of risk concerning the state of the target 110 at each time point in the future when the state of the target 110 is measured based on the prediction result of the state of the target 110 at each time point in the future when the state of the target 110 is measured.

(Hardware Configuration Example of Reinforcement Learning Apparatus 100)

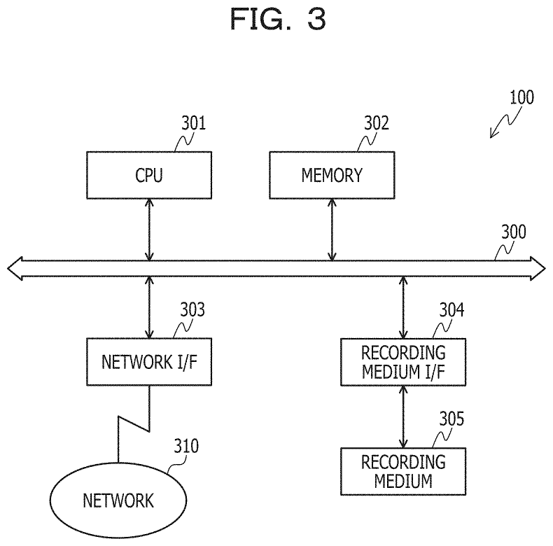

Next, a hardware configuration example of the reinforcement learning apparatus 100 illustrated in FIGS. 1 and 2 will be described with reference to FIG. 3.

FIG. 3 is a block diagram illustrating the hardware configuration example of the reinforcement learning apparatus 100. In FIG. 3, the reinforcement learning apparatus 100 includes a central processing unit (CPU) 301, a memory 302, a network interface (I/F) 303, a recording medium I/F 304, and a recording medium 305. These components are coupled to one another through a bus 300.

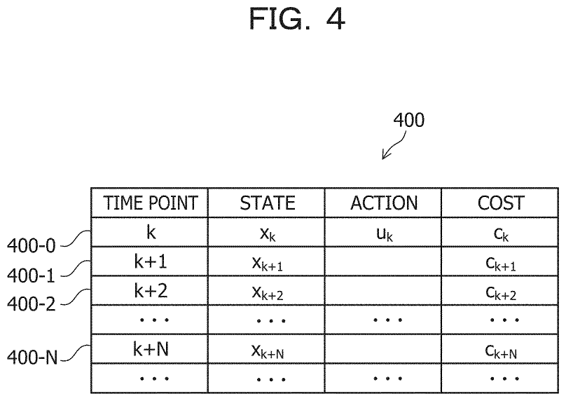

The CPU 301 controls the entirety of the reinforcement learning apparatus 100. The memory 302 includes, for example, a read-only memory (ROM), a random-access memory (RAM), a flash ROM, and the like. For example, the flash ROM and the ROM store various programs, and the RAM is used as a work area of the CPU 301. A program stored in the memory 302 is loaded into the CPU 301, thereby causing the CPU 301 to execute coded processing. The memory 302 stores a variety of information used for the reinforcement learning, for example. For example, the memory 302 stores a history table 400 to be described later with reference to FIG. 4.

The network I/F 303 is coupled to a network 310 through a communication line and is coupled to another computer via the network 310. The network I/F 303 controls the network 310 and an internal interface so as to control input and output of data to and from the other computer. Examples of the network I/F 303 include a modem, a local area network (LAN) adapter, and the like.

The recording medium I/F 304 controls writing and reading of the data to and from the recording medium 305 under the control of the CPU 301. Examples of the recording medium I/F 304 include, a disk drive, a solid-state drive (SSD), a Universal Serial Bus (USB) port, and the like. The recording medium 305 is a non-volatile memory that stores the data written under the control of the recording medium I/F 304. Examples of the recording medium 305 include a disk, a semiconductor memory, a USB memory, and the like. The recording medium 305 may be detachable from the reinforcement learning apparatus 100.

In addition to the above-described components, the reinforcement learning apparatus 100 may include, for example, a keyboard, a mouse, a display unit, a printer, a scanner, a microphone, a speaker, and the like. The reinforcement learning apparatus 100 may include multiple recording medium I/Fs 304 and multiple recording media 305, for example. The reinforcement learning apparatus 100 may exclude the recording medium I/F 304 or the recording medium 305, for example.

(Stored Contents of History Table 400)

Next, the stored contents of the history table 400 will be described with reference to FIG. 4. The history table 400 is implemented by a storage area such as the memory 302 and the recording medium 305 of the reinforcement learning apparatus 100 illustrated in FIG. 3, for example.

FIG. 4 is an explanatory diagram illustrating an example of the stored contents of the history table 400. As illustrated in FIG. 4, the history table 400 includes fields of time point, state, action, and cost. The history table 400 stores history information as a record 400-a by setting information in each field for each time point. Here, suffix a is an arbitrary integer. In the example of FIG. 4, the suffix a is an arbitrary integer in a range from 0 to N.

The time point to measure the state of the target 110 is set to the time point field. The time point expressed in the form of a multiple of unit time is set to the time point field, for example. The time point to measure the state of the target 110 may also be equivalent to the time point to determine the action to the target 110. For example, at each time in the course of measuring the state of the target 110 for the number of times equal to the multiple of N, the time point to measure the state of the target 110 is also equivalent to the time point to determine the action to the target 110.

The state of the target 110 at the time point set to the time point field is set to the state field. The action to the target 110 at the time point set to the time point field is set to the action field. The immediate cost measured at the time point set to the time point field is set to the cost field.

The history table 400 may include a reward field in place of the cost field in the case where the immediate rewards are used instead of the immediate costs in the reinforcement learning. The immediate reward measured at the time point set to the time point field is set to the reward field.

(Functional Configuration Example of Reinforcement Learning Apparatus 100)

Next, a functional configuration example of the reinforcement learning apparatus 100 will be described with reference to FIG. 5.

FIG. 5 is a block diagram illustrating the functional configuration example of the reinforcement learning apparatus 100. In the example of FIG. 5, the reinforcement learning apparatus 100 includes a storage unit 500, an acquisition unit 501, a calculation unit 502, a determination unit 503, a learning unit 504, and an output unit 505.

The storage unit 500 is implemented by using a storage area such as the memory 302 and the recording medium 305 illustrated in FIG. 3, for example. A description will be given below of a case where the storage unit 500 is included in the reinforcement learning apparatus 100. However, the embodiment is not limited to this configuration. For example, there may be a case where the storage unit 500 is included in a different device from the reinforcement learning apparatus 100 and the contents stored in the storage unit 500 are referable to from the reinforcement learning apparatus 100.

The units of the reinforcement learning apparatus 100 from the acquisition unit 501 to the output unit 505 collectively function as an example of a control unit 510. For example, functions of the units from the acquisition unit 501 to the output unit 505 are implemented by causing the CPU 301 to execute a program stored in the storage area such as the memory 302 and the recording medium 305 illustrated in FIG. 3 or by using the network I/F 303. Results of processing performed by the functional units are stored in the storage area such as the memory 302 and the recording medium 305 illustrated in FIG. 3, for example.

The storage unit 500 stores variety of information to be referred to or updated in the processing of the respective functional units. The storage unit 500 accumulates the states of the target 110, the actions to the target 110, and the immediate costs or the immediate rewards from the target 110 in the reinforcement learning. The storage unit 500 stores the history table illustrated in FIG. 4, for example. Thus, the storage unit 500 enables the respective functional units to refer to the states of the target 110, the actions to the target 110, and the immediate costs or the immediate rewards from the target 110.

The reinforcement learning is of an episode type, for example. In the episode type, either the period from the point of initialization of the state of the target 110 to the point of discontinuation of satisfaction of the constraint condition by the state of the target 110, or the period from the point of initialization of the state of the target 110 to the lapse of the given length of time is defined as the learning unit.

The target 110 may be a power generation facility, for example. The power generation facility may be a wind power generation facility, for example. In this case, the action in the reinforcement learning is power generator torque in the power generation facility, for example. The state in the reinforcement learning is at least any of an amount of power generation in the power generation facility, an amount of revolutions of a turbine in the power generation facility, a revolving speed of the turbine in the power generation facility, a direction of wind at the power generation facility, a wind velocity at the power generation facility, and the like. The reward in the reinforcement learning is the amount of power generation in the power generation facility, for example. The immediate reward in the reinforcement learning is an amount of power generation per unit time in the power generation facility, for example. For example, the power generation facility may be any of a thermal power generation facility, a solar power generation facility, a nuclear power generation facility, and the like.

The target 110 may be an air-conditioning facility, for example. The air-conditioning facility is installed in a server room, for example. In this case, the action in the reinforcement learning is at least any of a set temperature of the air-conditioning facility, a set air volume of the air-conditioning facility, and the like, for example. The state in the reinforcement learning is at least any of an actual temperature inside a room where the air-conditioning facility is installed, an actual temperature outside the room where the air-conditioning facility is installed, a weather, and the like, for example. The cost in the reinforcement learning is an amount of power consumption by the air-conditioning facility, for example. The immediate cost in the reinforcement learning is an amount of power consumption per unit time by the air-conditioning facility, for example.

The target 110 may be an industrial robot, for example. In this case, the action in the reinforcement learning is motor torque of the industrial robot, for example. The state in the reinforcement learning is at least any of a shot image of the industrial robot, a position of a joint of the industrial robot, an angle of the joint of the industrial robot, an angular velocity of the joint of the industrial robot, and the like, for example. The reward in the reinforcement learning is an amount of production of products by the industrial robot, for example. The immediate reward in the reinforcement learning is an amount of production of the products per unit time by the industrial robot, for example. The amount of production is the number of assemblies, for example. The number of assemblies is the number of products assembled by the industrial robot, for example.

In the reinforcement learning, the time interval to determine the action to the target 110 may be different from the time interval to measure the state of the target 110. For example, the time interval to determine the action to the target 110 may be longer than the time interval to measure the state of the target 110, and the state of the target 110 may transition two or more times during the period from the first determination of the action to the target 110 to the second determination of the action to the target 110 subsequent thereto. Accordingly, in the case of determining the action to the target 110, it is desirable to consider whether or not it is likely that the constraint condition is violated by every one of the states of the target 110 transitioning in the course of the determination of the subsequent action to the target 110.

The storage unit 500 stores the previous knowledge concerning the target 110. The previous knowledge is information based on at least any of specification values of the target 110, nominal values of parameters applied to the target 110, allowances of the parameters applied to the target 110, and the like. The previous knowledge includes model information concerning the target 110, for example. For example, the previous knowledge includes model information concerning the state of the target 110 at each time point in the future.

Each time point in the future is equivalent to the time point to measure the state of the target 110, which is included in the period from after the time point to determine the present action to the time point not later than determination of the subsequent action. In the following description, the period from after the time point to determine the present action to the time point not later than determination of the subsequent action may be referred to as an “action waiting period” as appropriate.

The model information is information that defines a relation between the state of the target 110 and the action to the target 110. The model information is expressed, for example, by subjecting a function of the state of the target 110 at a certain time point in the future to measure the state of the target 110, which is included in the action waiting period, to linear approximation. The model information is expressed, for example, by subjecting the function of the state of the target 110 at a certain time point in the future to measure the state of the target 110 to linear approximation while using a variable indicating the state of the target 110 and a variable indicating the action to the target 110 at the time point to determine the present action.

The storage unit 500 stores the degree of impact of the present action on the state of the target 110 at each time point in the future when the state the target 110 is measured, which is included in the action waiting period. For example, the degree of impact indicates how large a change in the present action will have an impact on a change in the state of the target 110 at a certain time point in the future when the state of the target 110 is measured, which is included in the action waiting period. Thus, the storage unit 500 enables the respective functional units to refer to the degrees of impact.

The storage unit 500 stores the value function. The value function defines a value of the action to the target 110 based on the cumulative cost or the cumulative reward from the target 110, for example. The value function is expressed by using a state basis function, for example. The value function is a state-action value function (Q function), a state value function (V function), or the like. The storage unit 500 stores parameters of the value function, for example. Thus, the storage unit 500 enables the respective functional units to refer to the value function.

The storage unit 500 stores a policy to control the target 110. The policy is a control rule for determining the action to the target 110, for example. The storage unit 500 stores the parameter w of the policy, for example. Thus, the storage unit 500 is capable of determining the action to the target 110 by using the policy.

The storage unit 500 stores one or more constraint conditions concerning the state of the target 110. The constraint condition is a constraint on the state of the target 110. Such a constraint condition defines an upper limit of a value indicating the state of the target 110, for example. Another constraint condition defines a lower limit of the value indicating the state of the target 110, for example. Such a constraint condition is linear relative to the state of the target 110, for example. Thus, the storage unit 500 enables the respective functional units to refer to the constraint conditions.

A description will be given below of an example of a case where the storage unit 500 stores the immediate costs on the assumption that the immediate costs are used in the reinforcement learning.

The acquisition unit 501 acquires a variety of information used for the processing of the respective functional units. The acquisition unit 501 stores the acquired variety of information in the storage unit 500 or outputs the information to the respective functional units. The acquisition unit 501 may output the variety of information stored in the storage unit 500 to the respective functional units. The acquisition unit 501 acquires the variety of information based on an operation input by a user, for example. The acquisition unit 501 may receive the variety of information from an apparatus different from the reinforcement learning apparatus 100.

The acquisition unit 501 acquires the state of the target 110 and the immediate cost from the target 110 corresponding to the action to the target 110. The acquisition unit 501 acquires the state of the target 110 and the immediate cost from the target 110 corresponding to the action to the target 110, and outputs the acquired information to the storage unit 500. Thus, the acquisition unit 501 enables the storage unit 500 to accumulate the states of the target 110 and the immediate costs from the target 110 corresponding to the action to the target 110.

The calculation unit 502 predicts the state of the target 110 at each time point in the future when the state of the target 110 is measured, which is included in the action waiting period, by using the previous knowledge concerning the target 110 for each time point to determine the action to the target 110 in the reinforcement learning.

For example, the calculation unit 502 calculates the predicted value of the state of the target 110 based on the model information and on an upper limit of an error included in the predicted value of the state of the target 110 at each time point in the future when the state of the target 110 is measured, which is included in the action waiting period. The upper limit of the error is preset by the user, for example. Thus, the calculation unit 502 makes it possible to calculate the degree of risk concerning the state of the target 110 at each time point in the future when the state of the target 110 is measured, which is included in the action waiting period.

The calculation unit 502 calculates the degree of risk concerning the state of the target 110 at each time point in the future when the state of the target 110 is measured, which is included in the action waiting period, for each time point to determine the action to the target 110 in the reinforcement learning. The degree of risk indicates the degree of likelihood that the state of the target 110 at a certain time point in the future when the state of the target 110 is measured violates the constraint condition, for example.

The calculation unit 502 calculates the degree of risk concerning the state of the target 110 at each time point in the future with respect to the constraint condition based on the prediction result of the state of the target 110 at each time point in the future when the state of the target 110 is measured, which is included in the action waiting period, for example.

For example, the calculation unit 502 calculates the degree of risk concerning the state of the target 110 at each time point in the future with respect to the constraint condition based on the predicted value of the state of the target 110 at each time point in the future when the state of the target 110 is measured, which is included in the action waiting period. Thus, the calculation unit 502 enables the determination unit 503 to refer to the degree of risk that represents an index for defining the search range for determining the present action.

The determination unit 503 determines the present action based on the search range concerning the present action for each time point when the action to the target 110 is determined in the reinforcement learning. The determination unit 503 determines the present action based on the search range adjusted in accordance with the degrees of risk concerning the states of the target 110 at the respective time points in the future as well as the degrees of impact of the present action on the states of the target 110 at the respective time points in the future. The determination unit 503 determines the present action based on the search range which is adjusted in such a way as to become narrower as the degree of risk is higher and to become narrower as the degree of impact is higher, for example.

For example, the determination unit 503 stochastically determines the present action under a probabilistic evaluation index concerning the satisfaction of the constraint condition. The evaluation index is preset by the user, for example. For example, the evaluation index indicates a lower limit of the probability that the state of the target 110 satisfies the constraint condition in the course of learning the policy by the reinforcement learning. For example, when the lower limit of the probability is 90%, the evaluation index is 0.9.

For example, the determination unit 503 calculates an mean value applicable to the present action. The determination unit 503 calculates a variance-covariance matrix under the evaluation index according to the calculated degrees of risk concerning the states of the target 110 at the respective time points in the future as well as the degrees of impact of the present action on the states of the target 110 at the respective time points in the future.

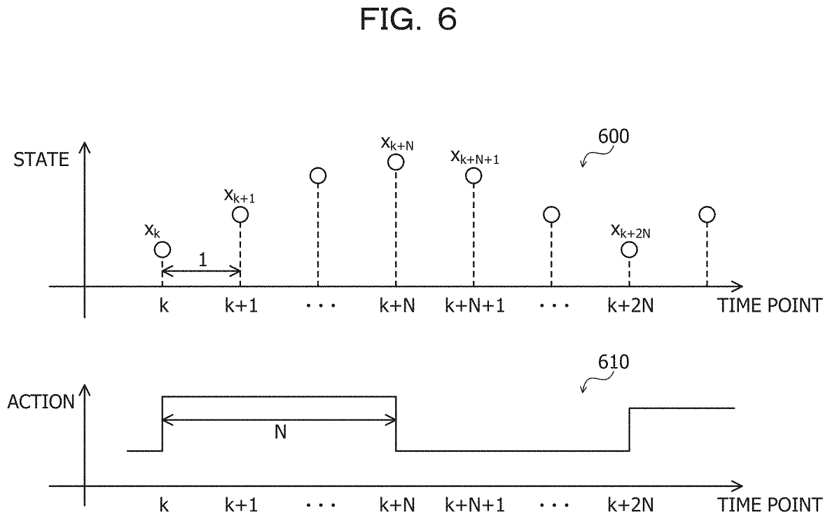

The determination unit 503 stochastically determines the present action based on the search range concerning the present action which is adjusted by using the calculated mean value and the calculated variance-covariance matrix. A specific example in which the determination unit 503 stochastically determines the present action will be described later as an operation example with reference to FIGS. 6 to 8, for example. Accordingly, the determination unit 503 is capable of reducing the probability that the state of the target 110 at each time point in the future violates the constraint condition by setting the narrower search range as the degree of risk is higher and setting the narrower search range as the degree of impact is higher.

For example, the determination unit 503 may determine a prescribed value for the present action when the degree of risk concerning the state of the target 110 at a certain time point in the future included in the action waiting period is equal to or above a threshold. The threshold is set to 0, for example.

When the state of the target 110 satisfies the constraint condition and the action has the value of 0 at a certain time point to measure the state, the target 110 may have such a property that the state of the target 110 is guaranteed to satisfy the constraint condition even at the time point when subsequent measurement of the state takes place. For this reason, it is preferable that the determination unit 503 use the value 0 as the prescribed value.

The determination unit 503 may determine a certain one of prescribed values for the present action. Thus, the determination unit 503 is capable of keeping the state of the target 110 at the time point in the future from violating the constraint condition.

For example, the determination unit 503 may stochastically determine the present action under the evaluation index when the calculated degree of risk concerning the state of the target 110 at each time point in the future falls below a threshold. The threshold is set to 0, for example. For example, when the calculated degree of risk concerning the state of the target 110 at each time point in the future falls below the threshold, the determination unit 503 calculates the mean value applicable to the present action. The determination unit 503 calculates a variance-covariance matrix under the evaluation index according to the calculated degrees of risk concerning the states of the target 110 at the respective time points in the future as well as the degrees of impact of the present action on the states of the target 110 at the respective time points in the future.

The determination unit 503 stochastically determines the present action based on the search range concerning the present action which is adjusted by using the calculated mean value and the calculated variance-covariance matrix. A specific example in which the determination unit 503 stochastically determines the present action will be described later as an operation example with reference to FIGS. 6 to 8, for example. Accordingly, the determination unit 503 is capable of reducing the probability that the state of the target 110 at each time point in the future violates the constraint condition by setting the narrower search range as the degree of risk is higher and setting the narrower search range as the degree of impact is higher.

The learning unit 504 learns the policy. The learning unit 504 updates the policy based on the determined action to the target 110, the acquired state of the target 110, and the immediate cost from the target 110. The learning unit 504 updates a parameter of the policy, for example. Thus, the learning unit 504 is capable of learning the policy that makes the target 110 controllable in such a way as to satisfy the constraint condition.

The output unit 505 outputs the action to the target 110 determined by the determination unit 503. The action is a command value for the target 110, for example. The output unit 505 outputs the command value for the target 110 to the target 110, for example. Accordingly, the output unit 505 is capable of controlling the target 110.

The output unit 505 may output a processing result of a certain one of the functional units. For example, the output is made in the form of display on a display unit, print output to a printer, transmission to an external device through the network I/F 303, or storage in the storage area such as the memory 302 and the recording medium 305. Thus, the output unit 505 is capable of notifying the user of the processing result of any of the functional units.

Although the description has been made above of the case where the storage unit 500 accumulates the immediate costs on the assumption that the reinforcement learning apparatus 100 uses the immediate costs in the reinforcement learning, the embodiment is not limited only to the foregoing. For example, there may be a case where the storage unit 500 accumulates the immediate rewards on the assumption that the reinforcement learning apparatus 100 uses the immediate rewards in the reinforcement learning.

Although the description has been made above of the case where the reinforcement learning apparatus 100 includes the units from the acquisition unit 501 to the output unit 505, the embodiment is not limited only to the foregoing. For example, another computer including any of the functional units of the acquisition unit 501 to the output unit 505 may be provided in addition to the reinforcement learning apparatus 100 and this computer may be configured to cooperate with the reinforcement learning apparatus 100.

(Operation Example of Reinforcement Learning Apparatus 100)

Next, an operation example of the reinforcement learning apparatus 100 will be described with reference to FIGS. 6 to 10.

FIGS. 6 to 10 are explanatory diagrams illustrating the operation example of the reinforcement learning apparatus 100. The operation example corresponds to the case where the reinforcement learning apparatus 100 guarantees at least the predetermined magnitude of the probability that the state of the target 110 satisfies the constraint condition in the course of learning the policy by the reinforcement learning.

In the following, a flow of the operation of the reinforcement learning apparatus 100 will be described first, then the example of the operation of the reinforcement learning apparatus 100 will be described by using mathematical expressions, and a specific operation example of the reinforcement learning apparatus 100 will be described by using an actual example.

<Flow of Operation of Reinforcement Learning Apparatus 100>

The following four characteristics are assumed concerning the reinforcement learning and the target 110. The first characteristic is that the reinforcement learning adopts the policy to stochastically determine the action and is capable of changing a variance-covariance matrix of a probability density function used for determining the action at any time.

The second characteristic is that the target 110 is a linear system and the constraint condition is linear relative to the state, and the variance of the action at a certain time point is saved and is effective relative to the state of the target 110 at each time point before the time point to determine the subsequent action.

The third characteristic is that the state of the target 110 does not transition from a state of satisfying the constraint condition to a state of not satisfying the constraint condition when the action has the value of 0 and the target 110 is in a situation to transition autonomously.

The fourth characteristic is that it is possible to express the state of the target 110 at each time point during the period from after the first determination of the action to the second determination of the action subsequent thereto by using the previous knowledge concerning the target 110. Examples of the previous knowledge include a known linear nominal model, an error function of which an upper bound is known, and the like. The error function represents a modeling error in a linear nominal model, for example.

The reinforcement learning apparatus 100 carries out the reinforcement learning by using the above-described characteristics. For example, the reinforcement learning apparatus 100 calculates the predicted value of the state at each time point before the time point to determine the subsequent action every time the reinforcement learning apparatus 100 determines the action. The reinforcement learning apparatus 100 determines whether or not the degree of risk concerning the state at each time point, which is calculated based on the predicted value of the state at the time point, is equal to or above the threshold.

There may be a case where the degree of risk concerning the state at a certain time point is equal to or above the threshold. In this case, the reinforcement learning apparatus 100 determines the value 0 for the action and causes the target 110 to transition autonomously. On the other hand, there may be a case where the degree of risk concerning the state at each time point falls below the threshold. In this case, the reinforcement learning apparatus 100 calculates the variance-covariance matrix under the probabilistic evaluation index and based on the degrees of risk concerning the states at the respective time points as well as the degrees of impact of the present action on the states at the respective time points. The reinforcement learning apparatus 100 stochastically determines the action based on the variance-covariance matrix thus calculated.

The evaluation index is preset by the user. The evaluation index represents a lower limit of a probability to satisfy the constraint condition, for example. In the following description, the probability to satisfy the constraint condition may be referred to as a “probability of constraint satisfaction” when appropriate.

For example, the reinforcement learning apparatus 100 determines the action in the reinforcement learning while adjusting the search range for determining the action in accordance with steps 1 to 7 described below, and applies the action to the target 110.

In step 1, the reinforcement learning apparatus 100 calculates an mean value of the action corresponding to a value of the state at a present time point. The mean value is a center value, for example.

In step 2, the reinforcement learning apparatus 100 calculates the predicted value of the state at each time point before the time point to determine the subsequent action based on the previous knowledge concerning the target 110, the mean value of the action calculated in step 1, and the value of the state at the present time point. The previous knowledge is information such as a linear nominal model concerning the target 110 and an upper bound of a modeling error. The reinforcement learning apparatus 100 calculates the degree of risk concerning the state at each time point before the time point to determine the subsequent action with respect to the constraint condition based on the predicted value of the state at the relevant time point.

In step 3, the reinforcement learning apparatus 100 proceeds to processing in step 4 when at least one of the degrees of risk calculated in step 2 is equal to or above the threshold, or proceeds to processing in step 5 when none of the degrees of risk calculated in step 2 is equal to or above the threshold.

In step 4, the reinforcement learning apparatus 100 determines the value 0 for the action, causes the target 110 to transition autonomously, and then proceeds to processing in step 7.

In step 5.1, the reinforcement learning apparatus 100 calculates a standard deviation based on a lower limit of the probability of constraint satisfaction, the degrees of risk concerning the states at the respective time points calculated in step 2, and the degrees of impact of the present action on the states at the respective time points. The lower limit of the probability of constraint satisfaction is preset by the user. The reinforcement learning apparatus 100 calculates the standard deviation for each state based on a lower limit of the constraint condition, the degree of risk concerning the state, and the degree of impact of the present action on the state, for example.

In step 5.2, the reinforcement learning apparatus 100 calculates the variance-covariance matrix used for stochastically determining the action based on the standard deviations calculated in step 5.1. For example, the reinforcement learning apparatus 100 specifies the smallest standard deviation out of the standard deviations calculated in step 5.1, and calculates the variance-covariance matrix used for stochastically determining the action based on the specified standard deviation.

In step 6, the reinforcement learning apparatus 100 stochastically determines the action in accordance with probability distribution using the mean value calculated in step 1 and the variance-covariance matrix calculated in step 5.2. The probability distribution is gaussian distribution, for example. The reinforcement learning apparatus 100 may set the value of the action to 0 when the determined action is out of a range of upper and lower limits of the action.

In step 7, the reinforcement learning apparatus 100 applies the action determined in step 4 or step 6 to the target 110.

In this way, the reinforcement learning apparatus 100 is capable of automatically adjusting the search range for determining the action in accordance with the degree of risk and the degree of impact. Accordingly, the reinforcement learning apparatus 100 is capable of guaranteeing that a probability that the state during the period from the first determination of the action to the second determination of the action subsequent thereto, in which the action in unchangeable, satisfies the constraint condition becomes equal to or above the preset lower limit. In the course of learning the policy by the reinforcement learning of the episode type, the reinforcement learning apparatus 100 is capable of guaranteeing that the probability that the state of the target 110 satisfies the constraint condition becomes equal to or above the preset lower limit at every time point in the episodes.

<Example of Operation of Reinforcement Learning Apparatus 100 Using Mathematical Expressions>

In the operation example, the following formulae (1) to (22) define the target 110, the immediate cost, the constraint condition, an additional condition, and a control purpose, thus setting a problem. The following formulae (23) to (31) define various characteristics concerning the reinforcement learning and the target 110 to be assumed in the operation example.

For example, the target 110 is defined by the following formulae (1) to (8).

xₖ₊₁=Axₖ+Buₖ (1)

The formula (1) defines a model that represents a true dynamic of the target 110. The model representing the true dynamic of the target 110 does not have to be known. The target 110 is a discrete time linear system which is linear relative to the action and the state. The state has a continuous value. The action has a continuous value. Code k represents a time point expressed in the form of a multiple of the unit time. Code k+1 represents a time point after a lapse of the unit time from the time point k. Code xₖ₊₁ represents a state at the time point k+1. Code xₖ represents a state at the time point k. Code uₖ represents an action at the time point k. Code A represents a coefficient matrix. Code B represents another coefficient matrix. The coefficient matrices A and B are unknown. The above-mentioned formula (1) represents a relation that the state xₖ₊₁ at the subsequent time point k+1 is determined by the state xₖ at the time point k and an input uₖ at the time point k.

A∈ [symbol] ^{n×m} (2)

B∈ [symbol] ^{n×m} (3)

The formula (2) represents that coefficient matrix A is an n×n-dimensional matrix. An outline letter R represents an actual space. A superscript beside the outline letter R represents the number of dimensions. The value n is known. The formula (3) represents that coefficient matrix B is an n×m-dimensional matrix. The value m is known.

xₖ∈ [symbol] ⁿ (4)

uₖ∈U (5)

The formula (4) represents that the state xₖ is n-dimensional. The value n is known. The state xₖ is directly measurable. The formula (5) represents that the action uₖ is defined by code U.

U={u=[u₁, . . . , uₘ]^{T}∈ [symbol] ^{m}|uᵢ^{min}≤uᵢ≤uᵢ^{max}, i=1, . . . , m} (6)

The formula (6) represents the definition U. The formula (6) defines that the action u is a vector that arranges the values u₁, . . . , uₘ and is m-dimensional, that a value uᵢ is in a range from a lower limit uᵢ^{min} to an upper limit uᵢ^{max} inclusive, and that the value i takes values of i=1, . . . , m.

uᵢ^{min}∈(−∞, 0] (7)

uᵢ^{max}∈[0, ∞) (8)

The formula (7) represents that the lower limit uᵢ^{min} of the action uᵢ is above −∞ and equal to or below 0 and therefore has a negative value. The formula (8) represents that the upper limit uᵢ^{max} of the action uᵢ is equal to or above 0 and below ∞ and therefore has a positive value.

For example, the immediate cost is defined by the following formulae (9) to (11).

cₖ₊₁=c(xₖ, uₖ) (9)

The formula (9) is an equation that defines the immediate cost of the target 110. Code cₖ₊₁ represents the immediate cost accrued after a lapse of the unit time in response to the action uk at the time point k. Code c( ) represents a function to obtain the immediate cost. The formula (9) expresses a relation that the immediate cost cₖ₊₁ is determined by the state xₖ at the time point k and the action uₖ at the time point k.

c: [symbol] ⁿ× [symbol] ^{m}→[0, ∞) (10)

c(0,0)=0 (11)

The formula (10) represents that the function c( ) is a function to obtain a positive value based on the n-dimensional array and the m-dimensional array. The function c( ) is unknown. The formula (11) represents that a calculation result of the function c(0, 0) is equal to 0.

For example, the constraint condition is defined by the following formulae (12) to (15).

h^{T}x≤d (12)

The formula (12) defines the constraint condition. Code x represents the state. An array h is set by the user. A superscript T represents transposition. A variable d is set by the user. The constraint condition is known and is linear relative to the state x. There is one constraint condition in this operation example.

h∈ [symbol] ⁿ (13)

d∈ [symbol] (14)

The formula (13) represents that the array h is n-dimensional. The formula (14) represents that the variable d is an actual number.

X={x∈ [symbol] ⁿ|h^{T}x≤d} (15)

The formula (15) represents a set X of the states x that satisfy the constraint condition. In the following description, an interior point of the set X may be referred to as X^{int} when appropriate.

For example, the additional condition is defined by the following formulae (16) to (19).

As illustrated in FIG. 6, the additional condition is defined such that the time interval to determine the actions is an integral multiple of the time interval to measure the status. A graph 600 in FIG. 6 illustrates the state at each time point, in which the vertical axis indicates the state and the horizontal axis indicates the time point. A graph 610 in FIG. 6 illustrates the action at each time point, in which the vertical axis indicates the action and the horizontal axis indicates the time point. For example, as illustrated in FIG. 6, the additional condition is defined such that it is possible to change the action once in every N times the state is changed.

uₖ₊ᵢ=uₖ (16)

The formula (16) represents that the action uₖ₊ᵢ is the same as the action uₖ. The value i takes values of i=1, 2, . . . , N−1. The value k is a multiple of N inclusive of 0. The value k takes values of k=0, N, 2N, and so on. For example, the formula (16) represents that the action is fixed until the state is changed N times.

xₖ₊ᵢ=Aᵢxₖ+Bᵢuₖ (17)

The formula (17) represents a function to calculate a state xₖ₊ᵢ at a certain time point in the future included in the period from the time point of the first determination of the action to the time point of the second determination of the action subsequent thereto. The value i takes values of i=1, 2, . . . , N. Code Aᵢ represents the coefficient matrix. Code Bᵢ represents the different coefficient matrix. The value k is a multiple of N inclusive of 0. The value k takes values of k=0, N, 2N, and so on.

Aᵢ=Aⁱ (18)

Bᵢ=Σₗ₌₀ⁱ⁻¹A^{l}B (19)

The formula (18) represents that a coefficient matrix Aᵢ is equivalent to the i-th power of the coefficient matrix A. The formula (19) represents that the coefficient matrix Bᵢ is equivalent to a sum of products of the l-th power of the coefficient matrix A and the coefficient matrix B. The value i takes values of i=1, 2, . . . , N.

The control purpose is defined by the following formulae (20) to (22).

$$\begin{matrix}J = {\sum }_{k = 0}^{∞} {γ}^{k} {c}_{k + 1} & ( 20 ) \\ γ ∈ ( 0 , 1 ] \text{:} discount rate & ( 21 )\end{matrix}$$

The formula (20) is an equation indicating the cumulative cost J, which defines the control purpose of the reinforcement learning. The control purpose of the reinforcement learning is to minimize the cumulative cost J, which is equivalent to learning of the policy to minimize the cumulative cost J. The learning of the policy is equivalent to updating of the parameter w that provides the policy. The value γ represents a discount rate. The formula (21) represents that the value γ is greater than 0 and equal to or below 1.

Pr{h^{T}xₖ≤d}≥η (22)

The formula (22) defines that the control purpose of the reinforcement learning is to guarantee that the probability of constraint satisfaction concerning the constraint condition at every time point k≥1 is equal to or above a preset lower limit ηϵ (0.5, 1). Code Pr( ) indicates a probability that the condition inside ( ) is satisfied. Every time point k≥1 includes the time point that is included between the time points to determine the action.

The following formulae (23) to (31) assume the various characteristics concerning the reinforcement learning and the target 110.

xₖ₊₁≅Âxₖ+\hat{B}uₖ (23)

The formula (23) defines a linear approximation model of the target 110. The linear approximation model is a linear nominal model, for example. The linear approximation model of the target 110 is assumed to be known. In the following description, the assumption that the linear approximation model of the target 110 is known may be referred to as an “assumption 1” as appropriate. Codes hat{A} and hat{B} represent coefficient matrices. The code hat{ } represents that a hat is placed above the corresponding letter.

Â∈ [symbol] ^{n×n} (24)

\hat{B}∈ [symbol] ^{n×m} (25)

The formula (24) represents that the coefficient matrix hat{A} is nxn-dimensional (formed from n rows by n columns). The formula (25) represents that the coefficient matrix hat{B} is n×m-dimensional (formed from n rows by m columns).

$$\begin{matrix}{e}_{i} ( x , u ; A , B , \hat{A} , \hat{B} ) := ( {A}_{i} - {\hat{A}}_{i} ) x + ( B - {\hat{B}}_{i} ) u = : {[ {e}_{i , 1} ( x , u ; A , B , \hat{A} , \hat{B} ) , … , {e}_{i , n} ( x , u , A , B , \hat{A} , \hat{B} ) ]}^{T} & ( 26 ) \\ {\overline{e}}_{i , j} \geq {sup}_{x ∈ {ℝ}^{\#} , u ∈ U} \vert {e}_{i , j} ( x , u ; A , B , \hat{A} , \hat{B} ) \vert & ( 27 ) \\ {\overline{e}}_{i , j} < ∞ & ( 28 )\end{matrix}$$

The formula (26) defines the error function that represents the modeling error in the linear approximation model of the target 110 with respect to the model representing the true dynamic of the target 110. The value eᵢ represents the error. The value i takes values of i=1, 2, . . . , N. Concerning the formula (26), there is a value bar{e_{i,j}} that satisfies the formulae (27) and (28), which is assumed to be known. The value j takes values of j=1, 2, . . . , n. The code bar{ } represents that a bar is placed above the corresponding letter. In the following description, the assumption that there is the known value bar{e_{i,j}} that satisfies the formulae (27) and (28) may be referred to as an “assumption 2” as appropriate. The assumption 2 represents that there is a known upper bound of the error eᵢ. Codes hat{Aᵢ} and hat{Bᵢ} represent coefficient matrices.

Âᵢ=Âⁱ (29)

\hat{B}ᵢ=Σₗ₌₀ⁱ⁻¹Â^{l}\hat{B} (30)

The formula (29) represents that the coefficient matrix hat{Aᵢ} is equivalent to the i-th power of the coefficient matrix hat{A}. The formula (30) represents that the coefficient matrix hat{Bᵢ} is equivalent to a sum of products of the l-th power of the coefficient matrix hat{A} and the coefficient matrix hat{B}. The value i takes values of i=1, 2, . . . , N.

It is assumed that Ax ϵ X holds true if x ϵ X is met. In the following description, the assumption that Ax ϵ X holds true if x ϵ X is met may be referred to as an “assumption 3” as appropriate. The assumption 3 represents that if the state x satisfies the constraint condition and the value of the action is equal to 0 at a certain time point, then the state x after the transition also satisfies the constraint condition at the subsequent time point after the lapse of the unit time.

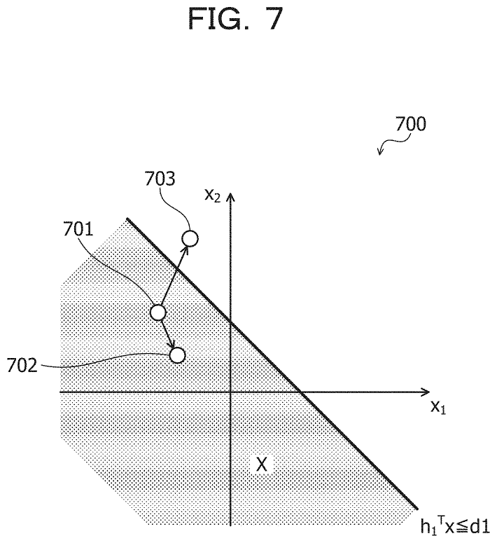

For example, if the value of the action is set to 0 when the present time point is in a state 701 in an actual space 700 as illustrated in FIG. 7, the state may transition to an interior point of the set X like a state 702 but will not transition to an exterior point of the set X like a state 703. Accordingly, when the value of the action is set to 0, it is possible to guarantee that the probability of constraint satisfaction concerning the state after the transition is increased to the lower limit or above.

h^{T}\hat{B}ᵢ≠0 (31)

The formula (31) is assumed to hold true for the coefficient matrix of the linear approximation model of the target 110 and for the constraint condition. In the following description, the assumption that the formula (31) holds true for the coefficient matrix of the linear approximation model of the target 110 and for the constraint condition may be referred to as an “assumption 4” as appropriate.

In the above-described problem setting, the target 110 is the linear system and the constraint condition is linear relative to the state. For this reason, a possible degree of variance of the action at a given time point is correlated with a possible degree of variance of the state at each time point in the future on and before the determination of the subsequent action. Accordingly, it is possible to control the degree of variance of the state at a certain time point in the future on and before the determination of the subsequent action by adjusting the possible degree of variance of the action at the given time point.

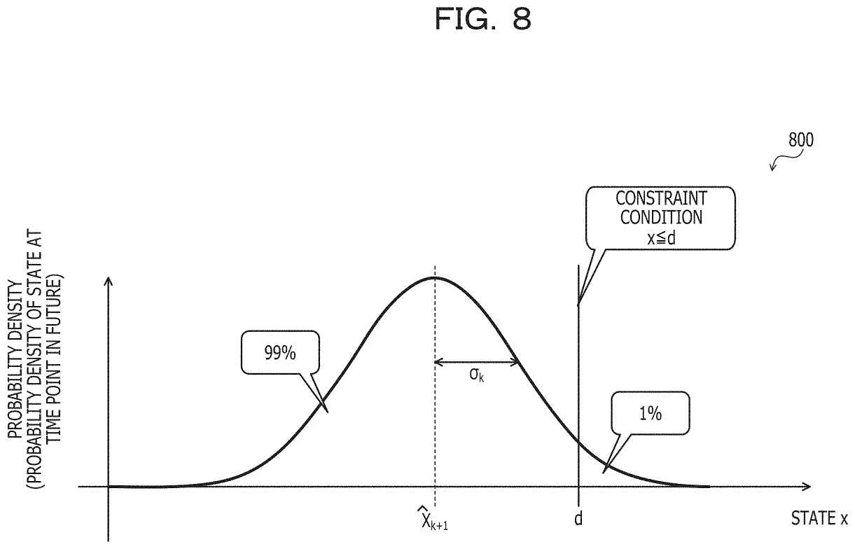

As a consequence, it is possible to guarantee that the probability of constraint satisfaction concerning the state at the certain time point in the future on and before the subsequent determination of the action is increased to the lower limit or above by adjusting the possible degree of variance of the action at the given time point. For example, as illustrated in a graph 800 in FIG. 8, it is possible to control a probability density of the state x at the certain time point in the future on and before the determination of the subsequent action in such a way that the probability of constraint satisfaction reaches 99% by adjusting the possible degree of variance of the action at the given time point

In this way, it is also possible to adjust the possible degree of variance of the action at the given time point, and thus to guarantee that the probability of constraint satisfaction concerning the state at each time point in the future on and before the subsequent determination of the action is increased to the lower limit or above. As a consequence, it is possible to guarantee that the probability of constraint satisfaction concerning the state at every time point is increased to the lower limit or above.

An example of the operation of the reinforcement learning apparatus 100 will be described based on the premise of the foregoing problem setting as well as the assumptions 1 to 4. According to the problem setting, the following formulae (32) and (33) hold true.

xₖ₊ᵢ=Âᵢxₖ+\hat{B}ᵢuₖ+eᵢ(xₖ, uₖ, A, B, Â, \hat{B}) (32)

xₖ₊ᵢ=Aᵢxₖ+Bᵢuₖ=Âᵢxₖ+\hat{B}ᵢuₖ+eᵢ(xₖ, uₖ) (33)

In step 1, the reinforcement learning apparatus 100 calculates an mean value μₖ of the action at the present time point with respect to the state xₖ at the present time point in accordance with the formula (34) while using the parameter ω that provides the policy and a state basis function φ( ). The value μₖ is m-dimensional.

μₖ=ϕ(xₖ)^{T}ω (34)

In step 2, the reinforcement learning apparatus 100 calculates the predicted value of the state at each time point in the future on and before the determination of the subsequent action inclusive of the error in accordance with the following formula (35) based on the model information indicating the linear nominal model concerning the target 110 and on the state xₖ at the present time point. The value εᵢ is defined by the following formulae (36) and (37), and is n-dimensional. A set of the entire values εᵢ is defined by the following formula (38), and is referred to as E.

x̅ₖ₊₁^{ε}=Âᵢxₖ+\hat{B}ᵢuₖ+εᵢ (35)

εᵢ=[ε_{i,1}, . . . , ε_{i,n}]^{T}∈ [symbol] ⁿ (36)

ε_{i,j}=ē_{i,j} or −ē_{i,j} (37)

E⊂ [symbol] ⁿ (38)

The reinforcement learning apparatus 100 calculates the degree of risk rₖ₊ᵢε concerning the state at each time point in the future on and before the determination of the subsequent action with respect to the constraint condition based on the calculated predicted value of the state in accordance with the following formula (39). The constraint condition is defined by the following formula (40). The degree of risk rₖ₊ᵢε is defined by the following formula (41) and is an actual number.

rₖ₊ᵢ^{ε}=−(d−h^{T}x̅ₖ₊ᵢ^{ε}) (39)

h^{T}xₖ₊ᵢ≤d (40)

rₖ₊ᵢ^{ε}∈ [symbol] (41)

In step 3, the reinforcement learning apparatus 100 proceeds to processing in step 4 when the following formula (42) holds true for the degree of risk rₖ₊ᵢε calculated in step 2, or proceeds to processing in step 5 when the formula (42) does not hold true.

¬(rₖ₊ᵢ^{ε}<0, ∀i=1,2, . . . , N, ∀_{ε}∈E) (42)

In step 4, the reinforcement learning apparatus 100 determines the value 0 for the action uₖ, and then proceeds to processing in step 7.

In step 5, the reinforcement learning apparatus 100 calculates the variance-covariance matrix in accordance with the following formulae (43) to (45) based on the degree of risk rₖ₊ᵢε calculated in step 2, the lower limit η of the probability of constraint satisfaction, and the degree of impact ρᵢ with respect to the state at each time point in the future. Code Iₘ is defined by the following formula (46) and represents an m×m-dimensional identity matrix. Code ϕ⁻¹( ) represents an inverse normal cumulative distribution function.

$$\begin{matrix}{ρ}_{i} := {‖ {h}^{T} {\hat{B}}_{i} ‖}_{2} & ( 43 ) \\ {\sum }_{k} = {\underline{σ}}_{k}^{2} {I}_{m} & ( 44 ) \\ {\underline{σ}}_{k} = {min}_{i , ɛ} \frac{1}{{ρ}_{i} {Φ}^{- 1} ( η )} \vert {r}_{k + i}^{ɛ} \vert & ( 45 ) \\ {I}_{m} ∈ {ℝ}^{m \times m} & ( 46 )\end{matrix}$$

In step 6, the reinforcement learning apparatus 100 sets the value pk calculated in step 1 and the value Σₖ calculated in step 5 as the mean value and the variance-covariance matrix, respectively, thereby generating a gaussian probability density function. The reinforcement learning apparatus 100 stochastically determines the action uk in accordance with the following formula (47) by using the gaussian probability density function.

uₖ˜N(μₖ, Σₖ) (47)

uₖ∉U (48)

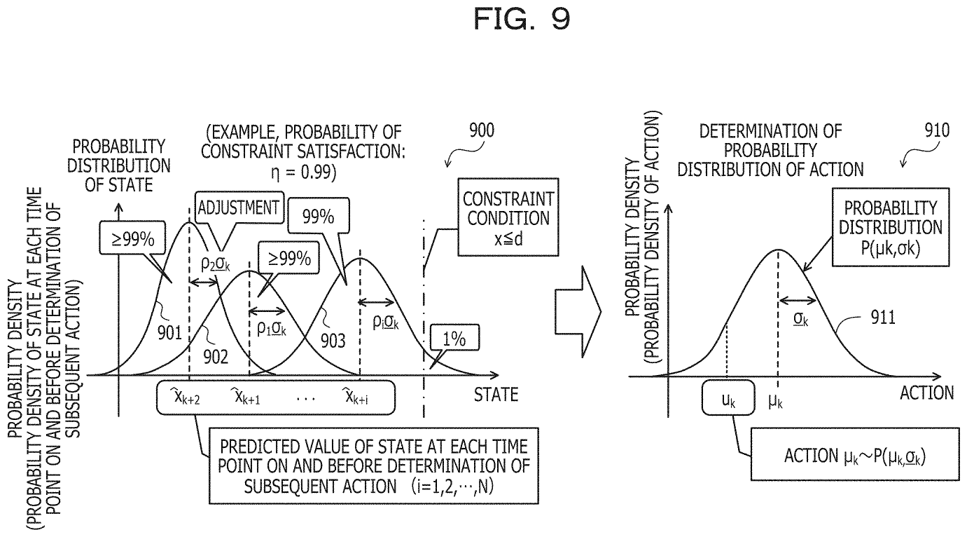

This enables the information processing apparatus to control the probability density of the state x at each time point in the future on and before the determination of the subsequent action in such a way as to satisfy the constraint condition at least at a predetermined probability. For example, as illustrated in a graph 900 in FIG. 9, it is desirable to determine the action uk such that even a probability density 903, which is most likely to violate the constraint condition among probability densities 901 to 903 of the states at the respective time points, satisfies the constraint condition at least at the predetermined probability.

In this regard, the minimum value is adopted in the formula (45) and the action uk is stochastically determined by the formula (47) in accordance with probability distribution 911 illustrated in a graph 910 in FIG. 9. As a consequence, the probability density 903 which is most likely to violate the constraint condition is capable of satisfying the constraint condition at least at the predetermined probability. Each of the probability densities 901 and 902 is capable of satisfying the constraint condition at least at the predetermined probability.

For example, when the action uk is determined by setting the value μₖ to the mean value and using the gaussian probability density function in accordance with the variance-covariance matrix Σₖ corresponding to an underscored standard deviation σₖ, the states at the respective time points also exhibit variance in accordance with the underscored standard deviation σₖ. As a consequence, each of the probability densities 901 to 903 is capable of satisfying the constraint condition at least at the predetermined probability.

The reinforcement learning apparatus 100 sets the value of the action uₖ equal to 0 when the determined action uk satisfies the formula (48).

In step 7, the reinforcement learning apparatus 100 applies the action uk determined in step 4 or step 6 to the target 110.

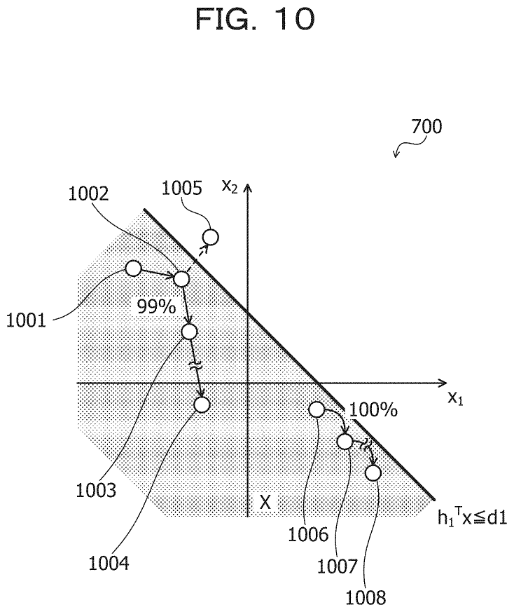

In this way, the reinforcement learning apparatus 100 is capable of automatically adjusting the search range for determining the action in accordance with the degree of risk and the degree of impact. Accordingly, in the course of learning the policy by the reinforcement learning of the episode type, the reinforcement learning apparatus 100 is capable of guaranteeing that the probability that the state of the target 110 satisfies the constraint condition becomes equal to or above the preset lower limit at every time point in the episodes. Next, FIG. 10 will be described. Here, a description will be given of the behavior of the reinforcement learning apparatus 100 to guarantee that the probability that the state of the target 110 satisfies the constraint condition at every time point in the episodes becomes equal to or above the preset lower limit.

In the example of FIG. 10, the value η is set equal to 0.99. As illustrated in FIG. 10, in the actual space 700, the reinforcement learning apparatus 100 controls the state of the target 110 to transition to the interior point of the set X at the probability η=0.99 even when the determination of the action turns out to be at the time point which is most likely to violate the constraint condition on and before the determination of the subsequent action.

In the example of FIG. 10, a time point at a destination of transition of the state subsequent to a time point corresponding to a state 1002 is assumed to be the time point which is most likely to violate the constraint condition. In this regard, the reinforcement learning apparatus 100 stochastically determines the action at a time point corresponding to a state 1001. Accordingly, the state transitions to an interior point of the set X like a state 1003 at the probability η=0.99 subsequent to a state 1002, or transitions to an exterior point of the set X like a state 1005 at a probability 1−η=0.01. Accordingly, the reinforcement learning apparatus 100 is capable of guaranteeing the satisfaction of the constraint condition at the probability η and above.

On the other hand, in the actual space 700, the reinforcement learning apparatus 100 sets the value of the action equal to 0 when the present time point corresponds to a state 1006, which is determined to be likely to violate the constraint condition on and before the determination of the subsequent action. Accordingly, the reinforcement learning apparatus 100 causes the state of the target 110 to continuously transition to the interior points of the set X like states 1007 and 1008 before the time point to determine the subsequent action, and is thus capable of guaranteeing the definite satisfaction of the constraint condition. In this way, the reinforcement learning apparatus 100 is capable of guaranteeing the satisfaction of the constraint condition at the probability η or above at every time point in the episodes.

Although the description has been made above of the case where the target 110 satisfies the assumption 3 by itself, the configuration of the embodiment is not limited only to the foregoing. For example, a controller for satisfying the assumption 3 may be designed in advance and the target 110 may be allowed to satisfy the assumption 3 by combining the controller with the target 110. This makes it possible to increase the number of cases of the target 110 to which the reinforcement learning apparatus 100 is applicable.

Although the description has been made above of the case where the model representing the true dynamic of the target 110 is unknown, the configuration of the embodiment is not limited only to the foregoing. For example, the model representing the true dynamic of the target 110 may be known. In this case, the reinforcement learning apparatus 100 does not have to use the linear approximation model. Instead, the reinforcement learning apparatus 100 is capable of calculating the predicted value of the state and the degree of risk by using the model representing the true dynamic, thereby improving accuracy to bring the probability of constraint satisfaction equal to or above the lower limit.

Although the description has been made above of the case where an accurate upper limit of the error is known, the configuration of the embodiment is not limited only to the foregoing. For example, there may be a case where the accurate upper limit of the error is unknown but an upper limit greater than the accurate upper limit of the error is known. The reinforcement learning apparatus 100 is capable of carrying out the reinforcement learning so as to bring the probability of constraint satisfaction equal to or above the lower limit in this case as well.

<Specific Operation Example of Reinforcement Learning Apparatus 100 Using Actual Example>

Next, a specific operation example of the reinforcement learning apparatus 100 will be described by using an actual example of a control problem. A description will be given of a specific operation example of the reinforcement learning apparatus 100 while using an actual example in which the target 110 includes two containers and a problem is to control the temperature inside each of the two containers at a target temperature. An action to the respective containers is assumed to be common. It is also assumed that there is no temperature interference between the containers.

A time-invariant temperature at 0° C. outside the containers is defined as a target temperature. The temperature inside each container is defined by the following formula (49) as the state xₖ, and a control input common to the containers is defined by the following formula (50) as the action uₖ.

xₖ=[x₁ₖ, x₂ₖ]^{T}∈ [symbol] ² (49)

uₖ∈[u^{min}, u^{max}]⊂ [symbol] (50)

The linear nominal model representing a change in temperature inside each container over time is defined by the following formula (51). The coefficient matrix hat{A} is defined by the following formula (52) and the coefficient matrix hat{B} is defined by the following formula (53). Here, the value Tₛ=60 represents sampling time. The value Cᵢ [J/° C.] represents a heat capacity of each container. The value Rᵢ [° C./W] represents a nominal value of heat resistance of an outer wall of each container. In the following description, the value C₁ is set equal to 20, the value R₁ is set equal to 15, the value C₂ is set equal to 40, and the value R₂ is set equal to 25. The linear nominal model is assumed to be known.

$$\begin{matrix}{x}_{k + 1} = \hat{A} {x}_{k} + \hat{B} {u}_{k} & ( 51 ) \\ \hat{A} = {I}_{2} - {T}_{s} [ \begin{matrix}\frac{1}{{C}_{1} {R}_{1}} & 0 \\ 0 & \frac{1}{{C}_{2} {R}_{2}}\end{matrix} ] & ( 52 ) \\ \hat{B} = {{T}_{S} [ \frac{1}{{C}_{1}} , \frac{1}{{C}_{2}} ]}^{T} & ( 53 )\end{matrix}$$

In the following description, the action is assumed to be changeable at every 5 minutes and the value N is set equal to 5.

The model that represents the true dynamic of the target 110 is defined by the following formula (54). A relation between the coefficient matrix A and the coefficient matrix hat{A} is defined by the following formula (55). A relation between the coefficient matrix B and the coefficient matrix hat{B} is defined by the following formula (56). The parameter ξ is defined by the following formula (57). The eigen value of the coefficient matrix A is defined by the following formula (58).

xₖ₊₁Axₖ+Buₖ (54)

A=Â (55)

B=(1+ξ)\hat{B} (56)

ξ=0.1 (57)

eig(A)=0.8,0.94 (58)

Upper and lower limit constraints of the action are defined as u^{max}=5 and uₘᵢₙ=−5, respectively.

In this case, an error of the state at each time point to measure the state between the model representing the true dynamic and the linear nominal model is defined by the following formula (59). The value e_{i,j} is defined by the following formula (60). The value j is defined by the following formula (61).

$$\begin{matrix}{e}_{i} ( x , u ; A , \hat{A} , B , \hat{B} ) = ( {A}_{i} - {\hat{A}}_{i} ) x - ( B - {\hat{B}}_{i} ) u = {\text{:} [ {e}_{i , 1} ( u ) , {e}_{i , 2} ( u ) ]}^{T} & ( 59 ) \\ {e}_{, j} ( u ) := - ξ \frac{1}{{C}_{j}} {\sum }_{l = 0}^{i - 1} {( \frac{1}{{C}_{j} {R}_{j}} )}^{l} u & ( 60 ) \\ j ∈ \{ 1 , 2 \} & ( 61 )\end{matrix}$$

There is a value bar{e_{i,j}} defined by the following formula (63) as the upper bound of the error that satisfies the following formula (62). The value bar{e_{i,j}} is assumed to be known. The code bar{ } represents that a bar is placed above the corresponding letter. The value i takes values of i=1, . . . , N.

$$\begin{matrix}{sup}_{x ∈ {ℝ}^{2} , u ∈ U} \vert {e}_{, j} ( u ) \vert \leq {\overline{e}}_{i , j} < ∞ & ( 62 ) \\ {\overline{e}}_{i , j} = \vert {e}_{, j} ( {u}^{max} ) \vert & ( 63 )\end{matrix}$$

The constraint condition with respect to the state is set to x₁≤10. Accordingly, the set X of the states that satisfy the constraint condition is defined by the following formula (64) while using h^{T}=[1, 0] and d=10. Accordingly, the point of origin x⁰=[0, 0]^{T} satisfies X₀ϵX. The assumption 3 holds true because all the absolute values of the eigen values of the coefficient matrix A fall below 1. An initial state is defined by the following formula (65).

X={x∈ [symbol] ²|h^{T}x≤d} (64)

x₀=[5, −8]^{T}∈X (65)

The coefficient matrix and the constraint condition of the linear nominal model satisfy the assumption 4 because h^{T}hat{B}ᵢ≠0 where i=0, 1, . . . , N holds true.

The immediate cost is defined by the following formula (66). The value Q is set to Q=1.0×10⁻¹I₂ and the value R is set to R=1.0×10⁻³.

cₖ₊₁=(Axₖ+Buₖ)^{T}Q(Axₖ+Buₖ)+Ruₖ² (66)

The reinforcement learning apparatus 100 carries out the reinforcement learning by using a reinforcement learning algorithm obtained by incorporating the above-described method of determining the action into the one-step actor-critic method. For example, the reinforcement learning apparatus 100 defines T=30 min as 1 episode, and learns the policy for determining the action to minimize the cumulative cost J of the immediate costs from an initial state x₀ in each episode. The term step is equivalent to a processing unit for measuring the immediate cost corresponding to the action at each time point to measure the state, which is expressed in the form of a multiple of the unit time. The cumulative cost J is defined by the following formula (67).

J=Σₖ₌₀^{T-1}cₖ₊₁ (67)

Since the value 0 is defined by the following formula (68) and the value ω is defined by the following formula (69), an estimated value hat{V(x;0)} of the value function and the mean value μ(x;ω) of the actions u are defined by the following formulae (70) and (71), respectively. The weight θ is Nθ-dimensional. The value ω is Nω-dimensional.

$$\begin{matrix}θ = {[ {θ}_{1} , … , {θ}_{{N}_{θ}} ]}^{T} ∈ {ℝ}^{{N}_{θ}} & ( 68 ) \\ ω = {[ {ω}_{1} , … , {ω}_{{N}_{ω}} ]}^{T} ∈ {ℝ}^{{N}_{ω}} & ( 69 ) \\ \hat{V} ( x ; θ ) = {\sum }_{i = 1}^{{N}_{θ}} {φ}_{i} ( x ) {θ}_{i} & ( 70 ) \\ μ ( x ; ω ) = {\sum }_{i = 1}^{{N}_{ω}} {φ}_{i} ( x ) {ω}_{i} & ( 71 )\end{matrix}$$

Code φᵢ( ) represents a gaussian radial basis function defined by the following formula (72). As defined by the following formula (73), the function φᵢ( ) transforms a two-dimensional array into a one-dimensional array. Codes bar{xᵢ} and sᵢ²>0 define the center point and variance of each basis function, respectively. As defined by the following formula (74), the value bar{xᵢ} is two-dimensional.

$$\begin{matrix}{φ}_{i} ( x ) = exp ( - \frac{{‖ x - {\overline{x}}_{i} ‖}^{2}}{2 {s}_{i}^{2}} ) & ( 72 ) \\ {φ}_{i} \text{:} {ℝ}^{2} \to ℝ & ( 73 ) \\ {\overline{x}}_{i} ∈ {ℝ}^{2} & ( 74 )\end{matrix}$$

The reinforcement learning apparatus 100 is assumed to have determined the action at each time point to determine the action in accordance with the formula (71) while applying the mean value μₖ(xₖ; ω) calculated by using the state xₖ at each time point to determine the action and the parameter ω.

The reinforcement learning apparatus 100 is also assumed to have updated the weight θ and the parameter ω in accordance with the following formulae (75) to (77) by using the immediate cost cₖ₊ᵢ at each time point to measure the state.

$$\begin{matrix}δ ← - {\sum }_{i = 1}^{N} {c}_{k + i} + γ \hat{V} ( {x}_{k + N} \text{;} θ ) - \hat{V} ( {x}_{k} ; θ ) & ( 75 ) \\ θ ← θ + α δ \frac{\partial \hat{V}}{\partial θ} ( {x}_{k} ; θ ) & ( 76 ) \\ ω ← ω + β δ \frac{\partial log Π}{\partial ω} ( {u}_{k} \vert {x}_{k} ; ω ) & ( 77 )\end{matrix}$$

Codes αϵ[0, 1) and βϵ[0, 1) represent learning rates, and Π( ) represents the gaussian probability density function adopting the value μₖ as the mean value and the value Σₖ as the variance-covariance matrix.

The reinforcement learning apparatus 100 terminates the present episode when the constraint condition is violated by x₁ₖ>10 or when k=T holds true. In this case, the reinforcement learning apparatus 100 is assumed to carry out initialization in accordance with the following formula (78) and to proceed to the next episode.

\hat{V}(x_{k+N}; θ)=0 (78)

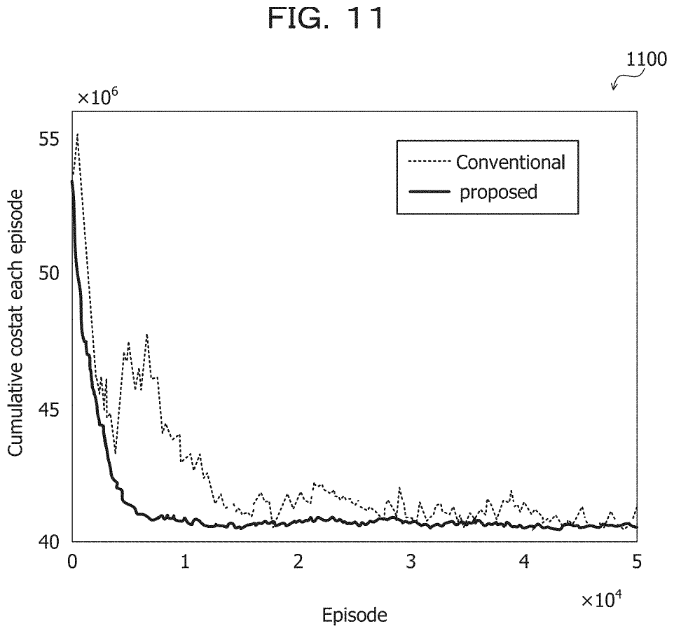

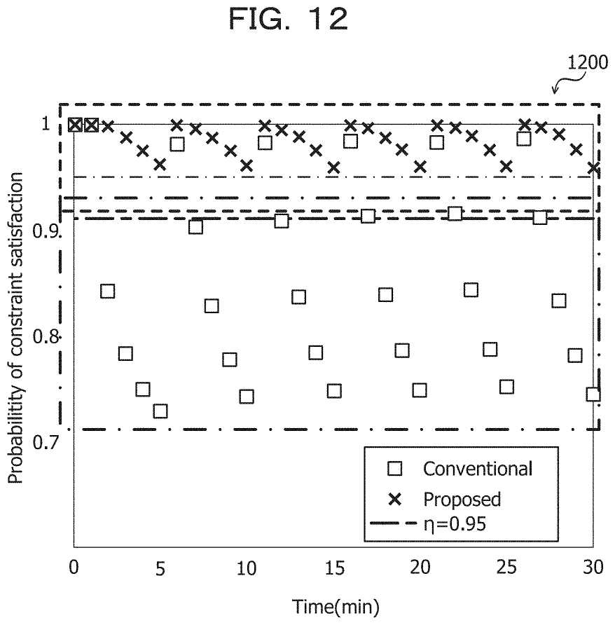

Thus, the reinforcement learning apparatus 100 is capable of automatically adjusting the search range for determining the action in accordance with the degree of risk and the degree of impact. Accordingly, in the course of learning the policy by the reinforcement learning of the episode type, the reinforcement learning apparatus 100 is capable of guaranteeing that the probability of constraint satisfaction becomes equal to or above the preset lower limit at every time point in the episodes. Next, effects obtained by the reinforcement learning apparatus 100 in the above-described actual example of the operation example will be described with reference to FIGS. 11 and 12.

FIGS. 11 and 12 are explanatory diagrams illustrating the effects obtained by the reinforcement learning apparatus 100 in the operation example. In FIGS. 11 and 12, the method for reinforcement learning by the reinforcement learning apparatus 100 will be compared with a different method for reinforcement learning that solely considers whether or not the state at each time point to determine the action satisfies the constraint condition. It is assumed that the lower limit of the probability of constraint satisfaction in the method for reinforcement learning by the reinforcement learning apparatus 100 and in the different method for reinforcement learning is defined by the following formula (79).

Pr{h^{T}xₖ≤d}≥η=0.95 (79)

A graph 1100 in FIG. 11 illustrates the cumulative cost in each of the episodes. The horizontal axis indicates the number of episodes. The vertical axis indicates the cumulative cost. The term “proposed” represents the method for reinforcement learning by the reinforcement learning apparatus 100. As illustrated in the graph 1100, the method for reinforcement learning by the reinforcement learning apparatus 100 is capable of reducing the cumulative cost with a fewer number of episodes as compared to the different method for reinforcement learning, thus improving learning efficiency of learning the appropriate policy.

A graph 1200 in FIG. 12 illustrates the probability of constraint satisfaction at each time point in an episode. The horizontal axis indicates the time point. The vertical axis indicates the probability of constraint satisfaction, which is a value obtained by dividing the number of episodes satisfying the constraint condition at each time point by the total number of episodes. As illustrated in the graph 1200, the method for reinforcement learning by the reinforcement learning apparatus 100 is capable of guaranteeing that the probability of constraint satisfaction becomes equal to or above the preset lower limit at every time point in the episodes. On the other hand, the different method for reinforcement learning is not capable of bringing the probability of constraint satisfaction equal to or above the preset lower limit.

As described above, in the course of learning the policy by the reinforcement learning, the reinforcement learning apparatus 100 is capable of guaranteeing that the probability of constraint satisfaction becomes equal to or above the preset lower limit, and suppressing reduction in learning efficiency.

Although the description has been made above of the case of setting the single constraint condition, the configuration of the embodiment is not limited only to the foregoing. For example, multiple constraint conditions may be set as appropriate. When all of the probabilities of constraint satisfaction regarding the multiple constraint conditions are uncorrelated with one another, the reinforcement learning apparatus 100 is capable of bringing the probability of simultaneous satisfaction of the multiple constraint conditions equal to or above the lower limit by bringing the probabilities of constraint satisfaction regarding the respective constraint conditions equal to or above the lower limit as with the operation example.

(Specific Examples of Target 110 Applying Reinforcement Learning)

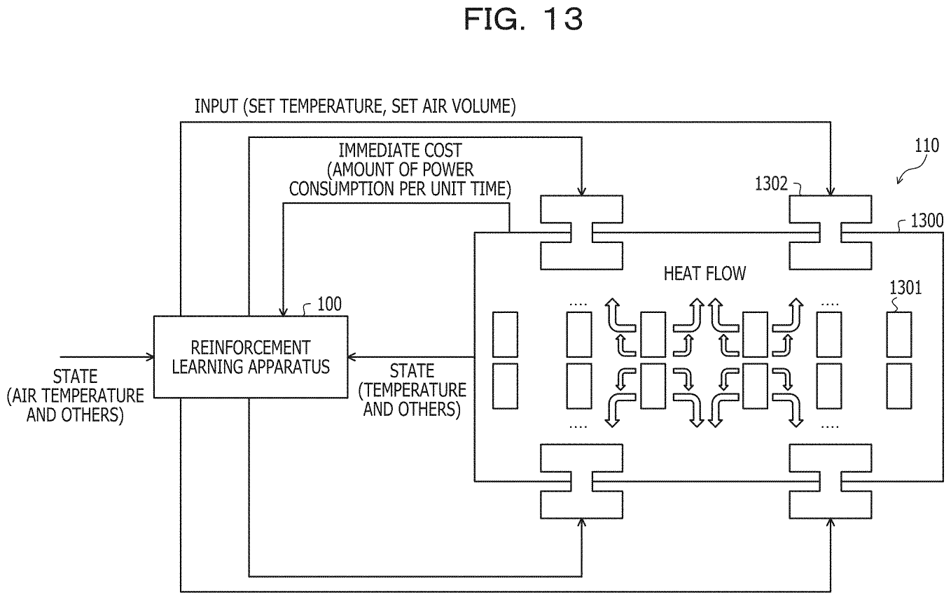

Next, specific examples of the target 110 applicable to the reinforcement learning will be described with reference to FIGS. 13 to 15.

FIGS. 13 to 15 are explanatory diagrams illustrating specific examples of the target 110. In the example of FIG. 13, the target 110 is a server room 1300 including a server 1301 being a heat source and a cooler 1302 such as CRAC and Chiller. The action is a set temperature or a set air volume for the cooler 1302. The time interval to determine each action is a time interval to change the set temperature or the set air volume, for example.

The state is sensor data from a sensor device provided inside or outside the server room 1300, such as the temperature. The time interval to measure the state is a time interval to measure the temperature, for example. The constraint condition includes upper and lower limit constraints of the temperature, for example. The state may be data related to the target 110 obtained from a target other than the target 110, which may be the air temperature or the weather, for example. The time interval to measure the state may be a time interval to measure the air temperature or the weather, for example.

The immediate cost is an amount of power consumption per unit time by the server room 1300, for example. The unit time is set to 5 minutes, for example. A goal is to minimize a cumulative amount of power consumption by the server room 1300. A state value function represents a value of the action regarding the cumulative amount of power consumption by the server room 1300, for example. The previous knowledge concerning the target 110 includes, for example, a floor area of the server room 1300, materials of an outer wall and a rack installed in the server room 1300, and the like.

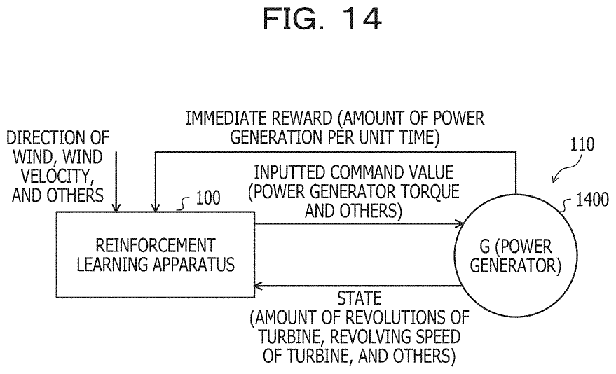

In the example of FIG. 14, the target 110 is a power generation facility 1400. The power generation facility 1400 may be a wind power generation facility, for example. The action is a command value for the power generation facility 1400. The command value is power generator torque of a power generator installed in the power generation facility 1400, for example. The time interval to determine the action is a time interval to change the power generator torque, for example.

The state is sensor data from a sensor device provided to the power generation facility 1400, examples of which include an amount of power generation in the power generation facility 1400, an amount of revolutions or a revolving speed of a turbine in the power generation facility 1400, and the like. The state may be a direction of wind or a wind velocity at the power generation facility 1400, and the like. The time interval to measure the state is a time interval to measure any of the amount of power generation, the amount of revolutions, the revolving speed, the direction of wind, and the wind velocity mentioned above, for example. The constraint condition includes upper and lower limit constraints of the revolving speed, for example.

The immediate reward is the amount of power generation per unit time in the power generation facility 1400, for example. The unit time is set to 5 minutes, for example. A goal is to maximize a cumulative amount of power generation in the power generation facility 1400, for example. A state value function represents a value of the action regarding the cumulative amount of power generation in the power generation facility 1400, for example. The previous knowledge concerning the target 110 includes, for example, specifications of the power generation facility 1400, and nominal values as well as allowances (tolerances) of parameters such as moment of inertia.

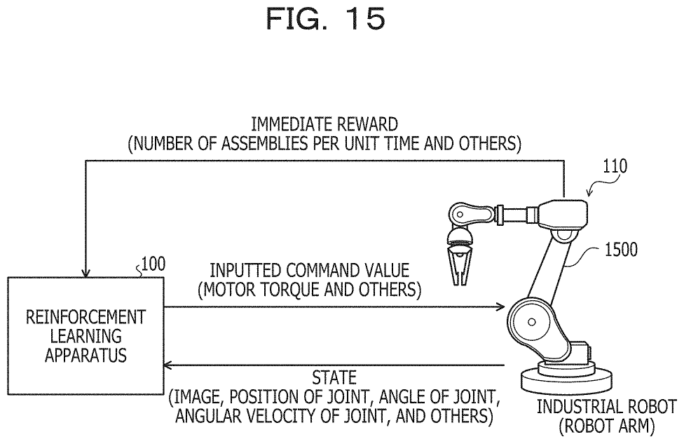

In the example of FIG. 15, the target 110 is an industrial robot 1500. The industrial robot 1500 is a robot arm, for example. The action is a command value for the industrial robot 1500. The command value is motor torque of the industrial robot 1500, for example. The time interval to determine the action is a time interval to change the motor torque, for example.

The state is sensor data from a sensor device provided to the industrial robot 1500, examples of which include a shot image of the industrial robot 1500, a position of a joint of the industrial robot 1500, an angle of the joint, an angular velocity of the joint, and the like. The time interval to measure the state is a time interval to shoot the image or to measure any of the position of the joint, the angle of the joint, and the angular velocity of the joint mentioned above, for example. The constraint condition includes ranges of movement of the position of the joint, the angle of the joint, and the angular velocity of the joint mentioned above, for example.

The immediate reward is the number of assemblies per unit time by the industrial robot 1500, for example. A goal is to maximize productivity of the industrial robot 1500. A state value function represents a value of the action regarding the cumulative number of assemblies by the industrial robot 1500, for example. The previous knowledge concerning the target 110 includes, for example, specifications of the industrial robot 1500, and nominal values as well as allowances (tolerances) of parameters such as dimensions of the robot arm.

The target 110 may be a simulator of any of the above-described specific examples. The target 110 may be a power generation facility other than the wind power generation facility. For example, the target to be controlled 110 may be a chemical plant, an autonomous mobile robot, or the like. The target 110 may be a vehicle such as an automobile. For example, the target 110 may be a flying object such as a drone and a helicopter. The target 110 may be a game, for example.

(Holistic Processing Procedures)

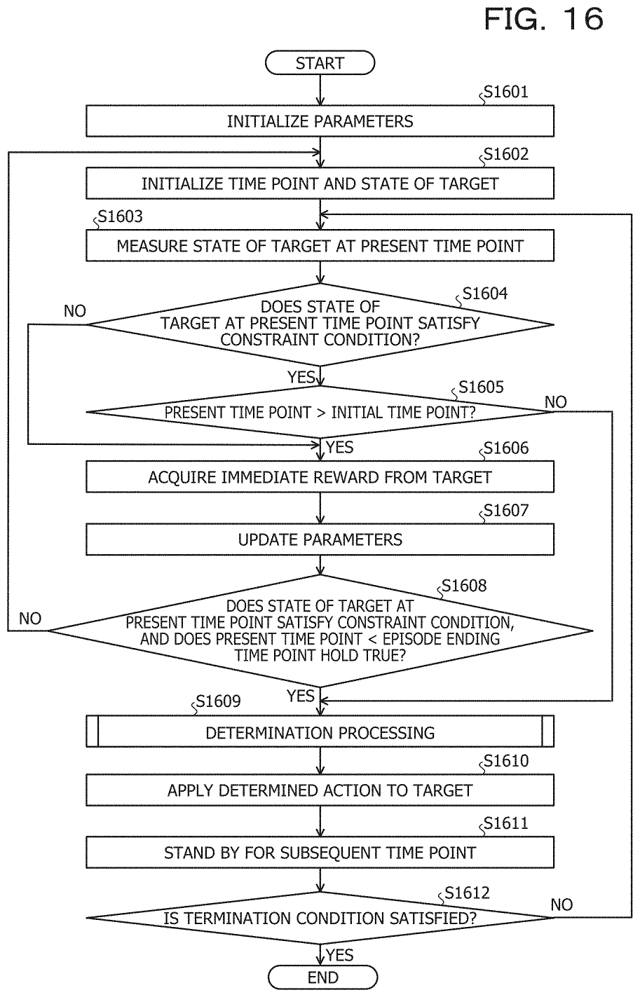

Next, an example of holistic processing procedures to be executed by the reinforcement learning apparatus 100 will be described with reference to FIG. 16. The holistic processing is implemented, for example, by the CPU 301, the storage area such as the memory 302 and the recording medium 305, and the network I/F 303 illustrated in FIG. 3.

FIG. 16 is a flowchart illustrating an example of the holistic processing procedures. In FIG. 16, the reinforcement learning apparatus 100 initializes the parameters (step S1601).

Next, the reinforcement learning apparatus 100 initializes the time point and the state of the target 110 (step S1602). The reinforcement learning apparatus 100 measures the state of the target 110 at the present time point (step S1603).

Next, the reinforcement learning apparatus 100 determines whether or not the state of the target 110 at the present time point satisfies the constraint condition (step S1604). When the constraint condition is satisfied (step S1604: Yes), the reinforcement learning apparatus 100 proceeds to the processing of step S1605. On the other hand, when the constraint condition is not satisfied (step S1604: No), the reinforcement learning apparatus 100 proceeds to the processing of step S1606.

In step S1605, the reinforcement learning apparatus 100 determines whether or not the present time point>an initial time point holds true (step S1605). When the present time point>the initial time point does not hold true (step S1605: No), the reinforcement learning apparatus 100 proceeds to the processing of step S1609. When the present time point>the initial time point holds true (step S1605: Yes), the reinforcement learning apparatus 100 proceeds to the processing of step S1606.

In step S1606, the reinforcement learning apparatus 100 acquires the immediate reward from the target 110 (step S1606). Next, the reinforcement learning apparatus 100 updates the parameters (step S1607). The reinforcement learning apparatus 100 determines whether or not the state of the target 110 at the present time point satisfies the constraint condition and the present time point<an episode ending time point holds true (step S1608).

When the constraint condition is not satisfied or the present time point<the episode ending time point does not hold true (step S1608: No), the reinforcement learning apparatus 100 returns to the processing of step S1602. On the other hand, when the constraint condition is satisfied and the present time point<the episode ending time point holds true (step S1608: Yes), the reinforcement learning apparatus 100 proceeds to the processing of step S1609.

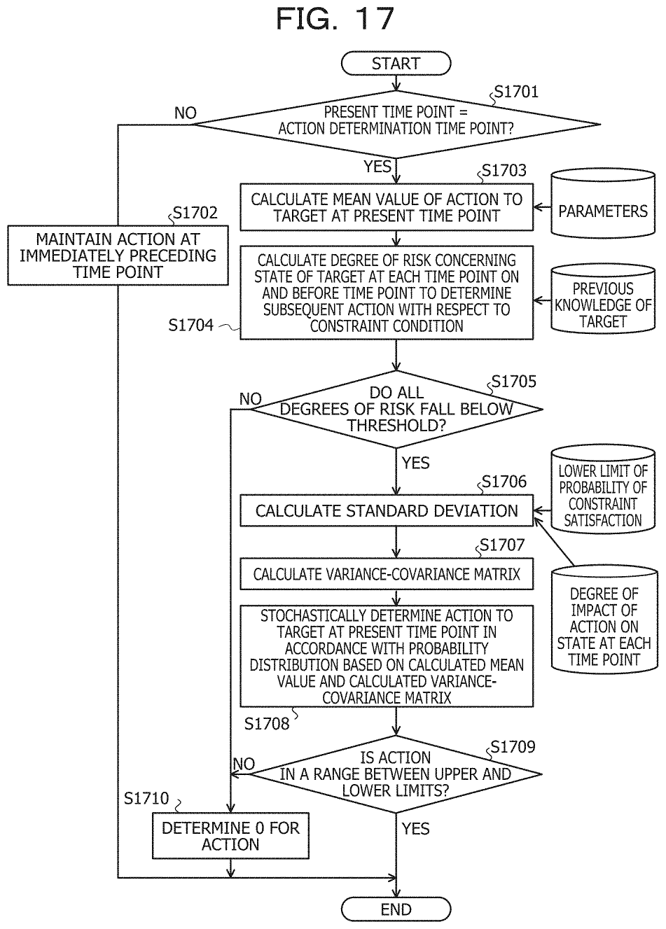

In step S1609, the reinforcement learning apparatus 100 executes determination processing to be described later with reference to FIG. 17, and determines the action to the target 110 at present time point (step S1609). Next, the reinforcement learning apparatus 100 applies the determined action to the target 110 (step S1610). The reinforcement learning apparatus 100 stands by for the subsequent time point (step S1611).

Next, the reinforcement learning apparatus 100 determines whether or not a termination condition is satisfied (step S1612). When the termination condition is not satisfied (step S1612: No), the reinforcement learning apparatus 100 returns to the processing of step S1603. On the other hand, when the termination condition is satisfied (step S1612: Yes), the reinforcement learning apparatus 100 terminates the holistic processing.

(Determination Processing Procedures)

Next, an example of determination processing procedures to be executed by the reinforcement learning apparatus 100 will be described with reference to FIG. 17. The determination processing is implemented, for example, by the CPU 301, the storage area such as the memory 302 and the recording medium 305, and the network I/F 303 illustrated in FIG. 3.

FIG. 17 is a flowchart illustrating an example of the determination processing procedures. In FIG. 17, the reinforcement learning apparatus 100 determines whether or not the present time point =an action determination time point holds true (step S1701).

When the present time point=the action determination time point holds true (step S1701: Yes), the reinforcement learning apparatus 100 proceeds to the processing of step S1703. On the other hand, when the present time point=the action determination time point does not hold true (step S1701: No), the reinforcement learning apparatus 100 proceeds to the processing of step S1702.

In step S1702, the reinforcement learning apparatus 100 maintains the action at the immediately preceding time point (step S1702). The reinforcement learning apparatus 100 terminates the determination processing.

In step S1703, the reinforcement learning apparatus 100 calculates the mean value of the action to the target 110 at the present time point with reference to the parameters (step S1703).

Next, the reinforcement learning apparatus 100 calculates the predicted value of the state of the target 110 at each time point on and before the time point to determine the subsequent action and calculates the degree of risk concerning the state of the target 110 at each time point with respect to the constraint condition with reference to the previous knowledge concerning the target 110 (step S1704). The previous knowledge includes the linear approximation model of the target 110 and the like.

The reinforcement learning apparatus 100 determines whether or not all the calculated degrees of risk fall below the threshold (step S1705). When at least one of the degrees of risk is equal to or above threshold (step S1705: No), the reinforcement learning apparatus 100 proceeds to the processing of step S1710. On the other hand when all the degrees of risk fall below threshold (step S1705: Yes), the reinforcement learning apparatus 100 proceeds to the processing of step S1706.

In step S1706, the reinforcement learning apparatus 100 calculates the standard deviation with reference to the calculated degrees of risk, the preset lower limit of the probability of constraint satisfaction, and the degrees of impact of the action (step S1706). Next, the reinforcement learning apparatus 100 calculates the variance-covariance matrix based on the minimum value of the calculated standard deviation (step S1707). The reinforcement learning apparatus 100 stochastically determines the action to the target 110 at the present time point in accordance with the probability distribution based on the calculated mean value and the calculated variance-covariance matrix (step S1708).

Next, the reinforcement learning apparatus 100 determines whether or not to the determined action is in the range between the upper and lower limits (step S1709). When the action is not in the range between the upper and lower limits (step S1709: No), the reinforcement learning apparatus 100 proceeds to the processing of step S1710. On the other hand, when the action is in the range between the upper and lower limits (step S1709: Yes), the reinforcement learning apparatus 100 terminates the determination processing.

In step S1710, the reinforcement learning apparatus 100 determines the value 0 for the action (step S1710). The reinforcement learning apparatus 100 terminates the determination processing.

As described above, according to the reinforcement learning apparatus 100, it is possible to calculate the degree of risk concerning the state at each time point in the future with respect to the constraint condition based on the prediction result of the state at each time point in the future included in the action waiting period. According to the reinforcement learning apparatus 100, it is possible to determine the present action based on the search range concerning the present action, which is adjusted in accordance with the calculated degrees of risk concerning the states at the respective time points as well as the degrees of impact of the present action on the states at the respective time points. Thus, the reinforcement learning apparatus 100 is capable of suppressing the increase in the probability that the state at each time point in the future violates the constraint condition.

According to the reinforcement learning apparatus 100, it is possible to determine the present action based on the search range which is adjusted in such a way as to become narrower as the degree of risk is higher and to become narrower as the degree of impact is higher. Thus, the reinforcement learning apparatus 100 is capable of efficiently suppressing the increase in the probability that the state at each time point in the future violates the constraint condition.

According to the reinforcement learning apparatus 100, it is possible to carry out the reinforcement learning in a situation where the time interval to determine the action the action is longer than the time interval to measure the state. Thus, the reinforcement learning apparatus 100 is capable of suppressing the increase in the probability that the state at each time point in the future violates the constraint condition even in a situation where it is difficult to control the probability that the state at each time point in the future violates the constraint condition.

According to the reinforcement learning apparatus 100, it is possible to stochastically determine the present action under the probabilistic evaluation index concerning the satisfaction of the constraint condition. Thus, the reinforcement learning apparatus 100 is capable of controlling the probability that the state at each time point in the future violates the constraint condition in such way as to satisfy the probabilistic evaluation index concerning the satisfaction of the constraint condition.

According to the reinforcement learning apparatus 100, it is possible to determine the prescribed value for the action when the degree of risk concerning the state at a certain time point included in the calculated period is equal to or above the threshold. According to the reinforcement learning apparatus 100, it is possible to stochastically determine the present action under the probabilistic evaluation index concerning the satisfaction of the constraint condition when the calculated degree of risk concerning the state at each time point is below the threshold. Thus, the reinforcement learning apparatus 100 is capable of facilitating the control of the probability that the state at each time point in the future violates the constraint condition in such way as to satisfy the probabilistic evaluation index concerning the satisfaction of the constraint condition.

According to the reinforcement learning apparatus 100, it is possible to calculate the mean value applicable to the resent action when the calculated degree of risk at each time point falls below the threshold. According to the reinforcement learning apparatus 100, it is possible to calculate the variance-covariance matrix under the probabilistic evaluation index concerning the satisfaction of the constraint condition in accordance with the calculated degrees of risk concerning the states at the respective time points as well as the degrees of impact of the present action on the states at the respective time points. According to the reinforcement learning apparatus 100, it is possible to stochastically determine the present action based on the search range concerning the present action which is adjusted by using the calculated mean value and the calculated variance-covariance matrix. Thus, the reinforcement learning apparatus 100 is capable of determining the action to the target 110 in accordance with the gaussian distribution.

According to the reinforcement learning apparatus 100, it is possible to use the value 0 as the prescribed value. Thus, the reinforcement learning apparatus 100 is capable of guaranteeing that the state at each time point in the future included in the action waiting period satisfies the constraint condition by using the characteristics of the target 110.

According to the reinforcement learning apparatus 100, it is possible to use the constraint condition which is linear relative to the state. Thus, the reinforcement learning apparatus 100 is capable of carrying out the reinforcement learning easily.

According to the reinforcement learning apparatus 100, it is possible to predict the state at each time point included in the period by using the previous knowledge concerning the target 110. Thus, the reinforcement learning apparatus 100 is capable of improving accuracy of prediction.

According to the reinforcement learning apparatus 100, it is possible to carry out the reinforcement learning to learn the policy to control the target 110 while adopting the power generation facility as the target 110. Thus, the reinforcement learning apparatus 100 is capable of controlling the power generation facility while reducing the probability of violation of the constraint condition in the course of learning the policy.

According to the reinforcement learning apparatus 100, it is possible to carry out the reinforcement learning to learn the policy to control the target 110 while adopting the air-conditioning facility as the target 110. Thus, the reinforcement learning apparatus 100 is capable of controlling the air-conditioning facility while reducing the probability of violation of the constraint condition in the course of learning the policy.

According to the reinforcement learning apparatus 100, it is possible to carry out the reinforcement learning to learn the policy to control the target 110 while adopting the industrial robot as the target 110. Thus, the reinforcement learning apparatus 100 is capable of controlling the industrial robot while reducing the probability of violation of the constraint condition in the course of learning the policy.

According to the reinforcement learning apparatus 100, it is possible to use the model information, which is expressed by subjecting the function of the state at each time point in the future included in the action waiting period to linear approximation while using the variable indicating the state and the variable indicating the action at the time point to determine the present action. Thus, the reinforcement learning apparatus 100 is capable of carrying out the reinforcement learning even when the model representing the true dynamic is unknown.

According to the reinforcement learning apparatus 100, it is possible to calculate the predicted value based on the model information and on the upper limit of the error included in the predicted value of the state at each time point in the future included in the action waiting period. Thus, the reinforcement learning apparatus 100 is capable of accurately obtaining the predicted value of the state while considering the error included in the predicted value of the state.

According to the reinforcement learning apparatus 100, it is possible to determine the action in the reinforcement learning of the episode type. Thus, the reinforcement learning apparatus 100 is capable of guaranteeing that the probability that the state satisfies the constraint condition becomes equal to or above the preset lower limit at every time point in the episodes.

According to the reinforcement learning apparatus 100, it is possible to provide the target 110 with the property that the state is guaranteed to satisfy the constraint condition at the time point when the subsequent measurement of the state takes place on the condition that the state satisfies the constraint condition and the action has the value of 0 at a certain time point to measure the state. Thus, the reinforcement learning apparatus 100 is capable of guaranteeing that the state of the target 110 at each time point in the future satisfies the constraint condition by using the property of the target 110.

It is possible to realize the method for reinforcement learning described according to the embodiment by causing a computer, such as a personal computer or a workstation, to execute a prepared program. The reinforcement learning program described according to the embodiment is recorded on a computer-readable recording medium, such as a hard disk, a flexible disk, a compact disc read-only memory (CD-ROM), a magneto-optical (MO) disc, or a digital versatile disc (DVD), and is executed as a result of being read from the recording medium by a computer. The reinforcement learning program described according to the present embodiment may be distributed through a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for reinforcement learning of causing a computer to execute a process comprising:
predicting a state of a target to be controlled in reinforcement learning at each time point to measure a state of the target, the time point being included in a period from after a time point to determine a present action to a time point not later than determination of a subsequent action, on a condition that a time interval to measure the state of the target is different from a time interval to determine the action to the target;
calculating a degree of risk concerning the state of the target at the each time point with respect to a constraint condition concerning the state of the target based on a result of prediction of the state of the target;
specifying a search range concerning the present action to the target in accordance with the calculated degree of risk concerning the state of the target at the each time point and a degree of impact of the present action to the target on the state of the target at the each time point; and
determining the present action to the target based on the specified search range concerning the present action to the target.

2. The method according to claim 1, wherein
in the specifying, the search range is specified such a way as to become narrower as the degree of risk is higher and to become narrower as the degree of impact is higher.

3. The method according to claim 1, wherein the time interval to determine the action to the target is longer than the time interval to measure the state of the target.

4. The method according to claim 1, wherein
in the specifying, the search range is specified under a probabilistic evaluation index concerning satisfaction of the constraint condition, and
in the determining, the present action to the target is stochastically determined based on the specified search range.

5. The method according to claim 1, wherein
in the specifying, the search range is specified under a probabilistic evaluation index concerning satisfaction of the constraint condition when the calculated degree of risk concerning the state of the target at each time point is below a threshold, and
in the determining, a prescribed value is determined for the action to the target when the calculated degree of risk concerning the state of the target at a certain time point included in the period is equal to or above a threshold and the present action to the target is stochastically determined based on the specified search range when the calculated degree of risk concerning the state of the target at each time point is below the threshold.

6. The method according to claim 5, wherein
in the specifying, when the calculated degree of risk concerning the state of the target at each time point is below the threshold, an mean value applicable to the present action to the target is calculated, then a variance-covariance matrix is calculated under a probabilistic evaluation index concerning satisfaction of the constraint condition in accordance with the calculated degree of risk concerning the state of the target at each time point and a degree of impact of the present action to the target on the state of the target at each time point, and the search range is specified by using the calculated mean value and the calculated variance-covariance matrix.

7. The method according to claim 5, wherein the prescribed value is equal to 0.

8. The method according to claim 1, wherein the constraint condition is linear relative to the state of the target.

9. The method according to claim 1, wherein the state of the target at each time point included in the period is predicted by using previous knowledge concerning the target.

10. The method according to claim 9, wherein
the target is a power generation facility,
the previous knowledge is information based on at least any of
a specification value of the power generation facility,
a nominal value of a parameter applied to the power generation facility, and
an allowance of the parameter applied to the power generation facility,
each of the calculating, the specifying, and the determining is executed in course of reinforcement learning to learn a policy to control the target by
defining power generator torque in the power generation facility as the action,
defining at least any of an amount of power generation in the power generation facility, an amount of revolutions of a turbine in the power generation facility, a revolving speed of the turbine in the power generation facility, a direction of wind at the power generation facility, and a wind velocity at the power generation facility as the state, and
defining the amount of power generation in the power generation facility as a reward,
the time interval to measure the state of the target is a time interval to measure at least any of the amount of power generation in the power generation facility, the amount of revolutions of the turbine in the power generation facility, the revolving speed of the turbine in the power generation facility, the direction of wind at the power generation facility, and the wind velocity at the power generation facility, and
the time interval to determine the action to the target is a time interval to determine the power generator torque in the power generation facility.

11. The method according to claim 9, wherein
the target is an air-conditioning facility,
the previous knowledge is information based on at least any of
a specification value of the air-conditioning facility,
a nominal value of a parameter applied to the air-conditioning facility, and
an allowance of the parameter applied to the air-conditioning facility,
each of the calculating, the specifying, and the determining is executed in course of reinforcement learning to learn a policy to control the target by
defining at least any of a set temperature of the air-conditioning facility and a set air volume of the air-conditioning facility as the action,
defining at least any of a temperature inside a room where the air-conditioning facility is installed, a temperature outside the room where the air-conditioning facility is installed, and a weather as the state, and
defining an amount of power consumption by the air-conditioning facility as a cost,
the time interval to measure the state of the target is a time interval to measure at least any of the temperature inside the room where the air-conditioning facility is installed, the temperature outside the room where the air-conditioning facility is installed, and the weather, and
the time interval to determine the action to the target is a time interval to determine at least any of the set temperature of the air-conditioning facility and the set air volume of the air-conditioning facility.

12. The method according to claim 9, wherein
the target is an industrial robot,
the previous knowledge is information based on at least any of
a specification value of the industrial robot,
a nominal value of a parameter applied to the industrial robot, and
an allowance of the parameter applied to the industrial robot,
each of the calculating, the specifying, and the determining is executed in course of reinforcement learning to learn a policy to control the target by
defining motor torque of the industrial robot as the action,
defining at least any of a shot image of the industrial robot, a position of a joint of the industrial robot, an angle of the joint of the industrial robot, and an angular velocity of the joint of the industrial robot as the state, and
defining an amount of production of products by the industrial robot as a reward,
the time interval to measure the state of the target is a time interval to measure at least any of the shot image of the industrial robot, the position of the joint of the industrial robot, the angle of the joint of the industrial robot, and the angular velocity of the joint of the industrial robot, and
the time interval to determine the action to the target is a time interval to determine the motor torque of the industrial robot.

13. The method according to claim 9, wherein
the previous knowledge includes model information expressed by subjecting a function of the state of the target at each time point to measure the state of the target, the time point being included in the period from after the time point to determine the present action to the time point not later than determination of the subsequent action, to linear approximation while using a variable indicating the state of the target and a variable indicating the action to the target at the time point to determine the present action.

14. The method according to claim 13, wherein
in the predicting, a predicted value of the state of the target is calculated based on the model information and on an upper limit of an error included in the predicted value at each time point to measure the state of the target, the time point being included in the period from after the time point to determine the present action to the time point not later than determination of the subsequent action.

15. The method according to claim 1, wherein
each of the calculating, the specifying, and the determining is executed in course of reinforcement learning of an episode type in terms of any of a period from a point of initialization of the state of the target to a point of discontinuation of satisfaction of the constraint condition by the state of the target and a period from the point of initialization of the state of the target to a lapse of a given length of time.

16. The method according to claim 1, wherein the target has a property that the state of the target is guaranteed to satisfy the constraint condition at the time point when subsequent measurement of the state takes place on a condition that the state of the target satisfies the constraint condition and the action to the target has a value of 0 at a certain time point to measure the state.

17. A non-transitory computer-readable storage medium having stored a reinforcement learning program for causing a computer to execute a process comprising:
predicting a state of a target to be controlled in reinforcement learning at each time point to measure a state of the target, the time point being included in a period from after a time point to determine a present action to a time point not later than determination of a subsequent action, on a condition that a time interval to measure the state of the target is different from a time interval to determine the action to the target;
calculating a degree of risk concerning the state of the target at the each time point with respect to a constraint condition concerning the state of the target based on a result of prediction of the state of the target;
specifying a search range concerning the present action to the target in accordance with the calculated degree of risk concerning the state of the target at the each time point and a degree of impact of the present action to the target on the state of the target at the each time point; and
determining the present action to the target based on the specified search range concerning the present action to the target.

18. A reinforcement learning apparatus comprising:
a memory, and
a processor coupled to the memory and configured to:
predict a state of a target to be controlled in reinforcement learning at each time point to measure a state of the target, the time point being included in a period from after a time point to determine a present action to a time point not later than determination of a subsequent action, on a condition that a time interval to measure the state of the target is different from a time interval to determine the action to the target;
calculate a degree of risk concerning the state of the target at the each time point with respect to a constraint condition concerning the state of the target based on a result of prediction of the state of the target;
specify a search range concerning the present action to the target in accordance with the calculated degree of risk concerning the state of the target at the each time point and a degree of impact of the present action to the target on the state of the target at the each time point; and
determine the present action to the target based on the specified search range concerning the present action to the target.
